(19) United States
(12) Patent Application Publication
(10) Pub. No.: US 2002/0059345 A1
(43) Pub. Date: May 16, 2002

(54) Method for generating transform rules for web-based markup languages

(76) Inventors: Wayne W. Wang, Los Gatos, CA (US); Joey Huang, Fremont, CA (US)

Correspondence Address: Jeffrey D. Wheeler, SONNENSCHEIN NATH & ROSENTHAL, Wacker Drive Station, Sears Tower, P.O. Box #061080, Chicago, IL, 60606-1080, US

(21) Appl. No.: 09/824,491

(22) Filed: Apr. 2, 2001

Related U.S. Application Data
(60) Provisional application No. 60/232,448, filed on Sep. 12, 2000.

(51) Int. Cl. G06F 15/00

(52) U.S. Cl. 707/513

(57) ABSTRACT

A method for use in generating a set of transform rules to be used in transforming existing web pages (or other information) for display (or playback, or the like) on associated web enabled Internet appliances. Information in a source page and a template page are identified as elements with an identifier and path name. User actions for arranging the elements are recorded are recorded onto at least a pair of stacks, which might include a redo stack, and an undo stack. The stacks are used as the basis for supporting the user actions. Chains of elements are generated from the stacks, and XSLT is provided from the chains. XSLT is associated with the transform rules, which reference the XSLT. The set of transform rules for the source pages are generated according to the source page URL, the XSLT, and the intended receiving device.

### RELATED APPLICATIONS

The present application claims priority of the Provisional application entitled “Automatic Transform Rule Generation for Web-Based Markup Languages,” filed on Sep. 12, 2000, by the inventors Wang et al., and assigned Ser. No. 60/232448, which is hereby incorporated by reference in its entirety. The present application is related to the Utility application entitled “Transform Rule Generator for Web-based Markup Languages,” filed on Jan. 24, 2001, and assigned Ser. No.______, which is hereby incorporated by reference in its entirety.

### FIELD OF THE INVENTION

A method for generating transform rules for use in transforming existing web pages (or other information) for display (or playback) in association with multiple Internet appliances such as computers, mobile phones, personal data assistants (PDAs), television set-top boxes, and the like.

### BACKGROUND OF THE INVENTION

The Internet is generally comprised of a distributed network of computers, wherein web servers on the network provide web sites that contain pages of information pertaining to various topics, businesses, and/or ventures. These web pages are provided to a web enabled device in response to a request for this information. Each web page generally has a unique URL (Universal Resource Locator) associated with it. A web enabled device such as a computer can send an HTML (Hypertext Markup Language) request for this URL to the web server. The web server then returns the page of web information in the general format that has been created by the web page designer in creating the information layout for that website (and its associated pages).

When PCs (personal computers) and the like are being used to request the information via a browser, no translation of the information generally needs to take place, as a browser running on a PC (with a full display) is the typical recipient of such web page information. Many new web enabled devices, however, do not have the display capabilities of a standard browser running on a full-display PC. If a standard web page were to be displayed on a device without sufficient display space, the web page information might not be completely visible and/or information might be lost. The information might also spill outside the bounds of the smaller display area, and therefore necessitate excessive scrolling (via browser functions, or the like) in order to view certain parts of the information. In general, the web page designer has no control over how the web page content will appear on the display device.

As a result, web designers have found it necessary to provide for the display of information contained within web pages of a web site on multiple Internet appliances. One such approach (herein referred to as the “duplication” approach) requires the web designer to provide a different set of web resources for each device type that might request the web page information. For example, the web designer would need to design and create one set of web pages for a PC with a full display, another set of web pages for a mobile phone device, and still another set for a PDA device. This duplication approach might also necessitate the separate web servers and URLs for each device type. In general, the duplication approach has at least the following drawbacks and limitations: (1) The duplicative effort in creating so many different web pages is labor intensive, in that the approach needs extra web designers and programmers for each device type involved. (2) It is generally hard to change web page style, and a redesign is generally required of all the pages and/or programs. (3) It is hard to synchronize web content among different devices. (4) It is difficult to scale for many device types (as a redesign generally needs to be done for each device).

Still another approach is referred to as the “general program approach.” According to this approach, some companies have developed general purpose programs to transform web pages for display on different device types. As such, the program generally transforms the web pages according to device capability. The transform is thereafter globally applied on all pages. At least one major limitation of this approach is that the web designer does not have sufficient control over the transformed layout. The transformation result generally depends upon the target device capability, meaning that the resulting page may not meet the requirements of the web designer.

Different approaches might be used to generate the transform rules as a result of a graphical approach being used for the layout of the resulting pages. What is needed in the field of art is an efficient method for generating the transform rules based upon different user actions. The graphical result might then be used to generate a set of transform rules that can be stored and thereafter applied to the web page if a request comes in to a web server from a particular device.

### SUMMARY OF THE INVENTION

The present invention provides an efficient and useful method for generating transform rules for existing web pages for display and use with a multitude of Internet appliances, such as PCs, mobile phones, PDAs, and television set-top boxes. The present invention provides a graphical editor that allows the designer to lay out device-specific web pages based upon original web pages that might comprise a web site. The editor thereafter uses a method to generate transform rules for this specific device at the end of editing, based upon the user actions. When certain web pages are requested by the specific device, the pages are transformed dynamically with the generated set of rules and displayed on the requesting device in a format intended by the designers.

The method of generating the transform rules uses a first frame for displaying the source page of web information from a server device (or the like). A second frame is used for displaying a resulting (or template) page. The information on the source and template page is separated into elements that are identified via attributes including an identifier and path information. Various user actions are performed for moving the elements from the source page to the template page. Buttons can be provided, including Undo, Redo, ViewXSLT, and Finish. The user actions for arranging the elements are recorded onto at least two stacks. These stacks might include, for instance, a “redostack” and an “undostack.”

The stacks are thereafter used as a basis for supporting the user actions. In other words, each of the user actions is stored in the stack, and can be used to generate a sequence of instructions for transforming the source page to the resulting page. The sequences are arranged via chains. Different types of chains of elements are generated from the at least two stacks, depending upon the actions being performed. The generated chains of elements are thereafter used in association with generating a set of transform rules. In the example embodiment, XSLT is provided from the generated chains. Thereafter a set of transform rules for the particular source page are generated according to the source page URL, XSLT, and the intended receiving device.

Certain representative user actions might include keystrokes for performing any of a variety of tasks. These tasks might include: Inserting the source element before the target element (example keystroke of “B”); Inserting the source element after the target element (example keystroke of “A”); Moving the source element to an absolute position (x, y) (example keystroke of “P”); Deleting the source element (example keystroke of“D”); Replacing the target element with the source element (example keystroke of “R”); Changing the attributes of the source element (example keystroke of “T”); Replacing the value of the source element with a new value (example keystroke of “V”); Inserting the source element just after the start tag of the target element (example keystroke of “S”); Inserting the source element just before the end tag element (example keystroke of“E”).

Accordingly, one aspect of the present invention provides a method for generating a set of transform rules to be used in transforming web-based information from a source page format to a web-enabled receiving device template page format, the transformation occurring in response to a request for the web-based information by the receiving device, the method comprising: displaying the source page and the template page using a graphical user interface; identifying elements within the information displayed on the source page and the template page; recording user actions for arranging the elements on the source page and the template page, the user actions being recorded onto at least two stacks, with certain stacks being associated with certain user actions; using the at least two stacks as the basis for supporting the user actions; generating chains of elements from the at least two stacks; providing XSLT from the generated chains; and generating the set of transform rules for the source page according to the source page URL, XSLT, and the intended receiving device.

These and other aspects and advantages of the present invention will become apparent upon reading the following detailed descriptions and studying the various figures of the drawings.

### BRIEF DESCRIPTION OF THE DRAWINGS

Certain aspects and advantages of the present invention will be apparent upon reference to the accompanying description when taken in conjunction with the following drawings, which are exemplary, wherein:

FIG. 1 is a block diagram, according to one aspect of the present invention, showing template and source pages, along with selection buttons.

FIG. 2 is a block diagram, according to one aspect of the present invention, showing representative user action selections.

FIG. 3A is a block diagram, according to one aspect of the present invention, showing the process of generating XSLT.

FIG. 3B is a block diagram, according to one aspect of the present invention, showing representative Transform Rule Generator file types.

FIG. 4A is a representative code sequence (pseudocode or other forms), according to one aspect of the present invention, showing a TagId structure.

FIG. 4B is a representative code sequence (pseudocode or other forms), according to one aspect of the present invention, showing a Statement structure.

FIG. 4C is a representative code sequence (pseudocode or other forms), according to one aspect of the present invention, showing a Stack structure.

FIG. 4D is a representative code sequence (pseudocode or other forms), according to one aspect of the present invention, showing an Element structure.

FIG. 4E is a representative code sequence (pseudocode or other forms), according to one aspect of the present invention, showing a Chain structure.

FIGS. 4F-4I are block diagrams, according to certain aspects of the present invention, showing a Chain structures.

FIG. 4J is a representative code sequence (pseudocode or other forms), according to one aspect of the present invention, showing a Card structure.

FIG. 4K is a representative code sequence (pseudocode or other forms), according to one aspect of the present invention, showing a Page structure.

FIG. 4L is a representative code sequence (pseudocode or other forms), according to one aspect of the present invention, showing an Attr structure.

FIG. 4M is a representative code sequence (pseudocode or other forms), according to one aspect of the present invention, showing a Unit structure.

FIG. 4N is a representative code sequence (pseudocode or other forms), according to one aspect of the present invention, showing a ElementInfo structure.

FIG. 4O is a representative code sequence (pseudocode or other forms), according to one aspect of the present invention, showing a Var structure.

FIG. 4P is a diagram, according to one aspect of the present invention, showing a Var tree structure.

FIGS. 5A-5C is a block diagram, according to one aspect of the present invention, showing representative macros that might be used with the Rule Generator.

FIG. 6A is a representative code sequence (pseudocode or other forms), according to one aspect of the present invention, showing a method Constructor.

FIG. 6B is a representative code sequence (pseudocode or other forms), according to one aspect of the present invention, showing a method Deconstructor.

FIG. 7A is a representative code sequence (pseudocode or other forms), according to one aspect of the present invention, showing a method PushStatement as associated with user actions B, A, R, S, and E.

FIG. 7B is a representative code sequence (pseudocode or other forms), according to one aspect of the present invention, showing a method PushStatement as associated with user actions P and D.

FIG. 7C is a representative code sequence (pseudocode or other forms), according to one aspect of the present invention, showing a method PushStatement as associated with user action T.

FIG. 7D is a representative code sequence (pseudocode or other forms), according to one aspect of the present invention, showing a method PushStatement as associated with user actions V.

FIG. 8A is a representative code sequence (pseudocode or other forms), according to one aspect of the present invention, showing a method UndoStatement.

FIG. 8B is a representative code sequence (pseudocode or other forms), according to one aspect of the present invention, showing a method RedoStatement.

FIGS. 9A-9E are a representative block diagrams, code sequences (pseudocode or other forms), and flowcharts, according to certain aspects of the present invention, showing the method GenerateXSLT.

FIG. 10 is a block diagram, according to one aspect of the present invention, showing representative private methods used with the Rule Generator.

FIG. 11A is a representative code sequence (pseudocode or other forms), according to one aspect of the present invention, showing the private method DestroyElement.

FIG. 11B is a representative code sequence (pseudocode or other forms), according to one aspect of the present invention, showing the private method DeleteElement.

FIGS. 12A-12B is a representative flowchart and code sequence (pseudocode or other forms), according to one aspect of the present invention, showing the private method DeleteChain.

FIG. 13A-13B is a representative code sequence (pseudocode or other forms), according to one aspect of the present invention, showing the private method LocateElement.

FIGS. 14A-14F are a representative block diagrams, code sequences (pseudocode or other forms), flowcharts, and tables, according to certain aspects of the present invention, showing the private method NewChain.

FIGS. 15A-15C is a representative flowchart and code sequence (pseudocode or other forms), according to one aspect of the present invention, showing the insertion of Elements into the new chain according to the action doBA.

FIG. 16 is a representative flowchart and code sequence (pseudocode or other forms), according to one aspect of the present invention, showing the insertion of Elements into the new chain according to the action doP.

FIG. 17 is a representative flowchart and code sequence (pseudocode or other forms), according to one aspect of the present invention, showing the insertion of Elements into the new chain according to the action doD.

FIG. 18 is a representative flowchart and code sequence (pseudocode or other forms), according to one aspect of the present invention, showing the insertion of Elements into the new chain according to the action doR.

FIG. 19 is a representative flowchart and code sequence (pseudocode or other forms), according to one aspect of the present invention, showing the insertion of Elements into the new chain according to the action doT.

FIG. 20 is a representative flowchart and code sequence (pseudocode or other forms), according to one aspect of the present invention, showing the insertion of Elements into the new chain according to the action doV.

FIGS. 21 is a representative flowchart and code sequence (pseudocode or other forms), according to one aspect of the present invention, showing the insertion of Elements into the new chain according to the action doSE.

FIG. 22 is a representative code sequence (pseudocode or other forms), according to one aspect of the present invention, showing the private method NewChildChain.

FIGS. 23A-23D are a representative block diagrams, code sequences (pseudocode or other forms), flowcharts, and tables, according to certain aspects of the present invention, showing the private method UpdateChain.

FIGS. 24A-24B is a representative flowchart and code sequence (pseudocode or other forms), according to one aspect of the present invention, showing updating the chain according to the action doBA.

FIG. 25 is a representative flowchart and code sequence (pseudocode or other forms), according to one aspect of the present invention, showing updating the chain according to the action doP.

FIG. 26 is a representative flowchart and code sequence (pseudocode or other forms), according to one aspect of the present invention, showing updating the chain according to the action doD.

FIG. 27 is a representative flowchart and code sequence (pseudocode or other forms), according to one aspect of the present invention, showing updating the chain according to the action doR.

FIGS. 28 is a representative flowchart and code sequence (pseudocode or other forms), according to one aspect of the present invention, showing updating the chain according to the action doT.

FIGS. 29 is a representative flowchart and code sequence (pseudocode or other forms), according to one aspect of the present invention, showing updating the chain according to the action doV.

FIGS. 30 is a representative flowchart and code sequence (pseudocode or other forms), according to one aspect of the present invention, showing updating the chain according to the action doSE.

FIG. 31 is a representative code sequence (pseudocode or other forms), according to one aspect of the present invention, showing the private method UpdateDelChain.

FIG. 32 is a representative code sequence (pseudocode or other forms), according to one aspect of the present invention, showing the private method FilterDelChain.

FIG. 33 is a representative code sequence (pseudocode or other forms), according to one aspect of the present invention, showing the private method AssemblyChain.

FIGS. 34A-34C is a representative code sequence (pseudocode or other forms), according to one aspect of the present invention, showing the private method ParseFrame.

FIG. 35 is a representative code sequence (pseudocode or other forms), according to one aspect of the present invention, showing the private method OutputVar.

FIG. 36 is a representative code sequence (pseudocode or other forms), according to one aspect of the present invention, showing the private method OutputChain.

FIG. 37 is a representative code sequence (pseudocode or other forms), according to one aspect of the present invention, showing the private method GetUnit.

### DESCRIPTION OF THE PREFERRED EMBODIMENTS

The present invention provides a method for generating (in an automated manner, as desired or otherwise) a set of transform rules that can be applied to source content material to provide result content material according to the capabilities of a device that is requesting the source content material. While the examples below are generally described in terms of visual display materials, other materials (i.e., sound, text, tables, data, etc.) are also intended to be enabled for playback/use on target receiving devices via the transformation process.

In the representative visual display embodiment described below, a graphical editor is provided that analyzes the source content material and assigns an identifier to each element. Certain editing functions are provided which allow a user to perform actions upon the identified elements, and in particular allow for the arrangement of a result according to the capabilities of a target receiving device. Thereafter, a set of transform rules are generated from the resulting layout and/or editing actions performed by the user. These transform rules are stored for application to the source content material when it is requested by the receiving device.

The present invention describes the general techniques for performing these functions in terms of web-oriented devices, include web pages, web servers, web sites, and network related examples. Accordingly, a set of source web pages are customized into resulting display pages using the graphical editing tool and command features therein. The method for generating transform rules (described herein as the “Transform Rule Generator”) produces a set of transform rules. The generated transform rules are thereafter applied to the source material by a proxy server (or other such) device. The proxy server receives requests from a web-enabled device, retrieves the requested source material from the appropriate web server, and then transforms the source material into the appropriate format for the receiving device, by applying the appropriate transform rules. Note that while the examples below pertain to web and/or network devices, the techniques described herein are intended to be applicable across other fields of art, wherein source material is to be transformed into resulting material for use by a receiving device.

The Transform Rule Generator (TRG) is used to generate transform rules according to the user actions on the template page and source page. As the user makes actions on the two pages, the TRG will record the user actions into two stacks, which serve as the basis for supporting unlimited redo/undo tasks. When the user wants to view the XSLT corresponding to the actions, or the user finishes customizing the source page, the TRG will generate Chains from the stacks, then XSLT from the Chains, and finally the rules for the source page.

Note that XSLT (XSL Transformations) is a standard way to describe how to transform (change) the structure of an XML (Extensible Markup Language) document into an XML document with a different structure. XSLT can be thought of as a part of the eXtensible Stylesheet Language (XSL) dealing with transformations. XSL is a language for expressing stylesheets. It consists of two parts: (1) XSLT: a language for transforming XML documents. (2) An XML vocabulary for specifying formatting semantics (XSL Formatting Objects). An XSL stylesheet specifies the presentation of a class of XML documents by describing how an instance of the class is transformed into an XML document that uses the formatting vocabulary. As background information on style sheets, reference is made to the Web Style Sheets resource page at the following website: http://www.w3.org/Style/XSL/. The information in this website, along with the information in its supporting links, are hereby incorporated by reference. XSL is being developed by the W3C XSL Working Group (Members Only) whose charter is to develop the subsequent versions of XSL.

The main data structures for the TRG are Statement, Stack, Element, Chain, Unit, and XsltVariable. “Statement” records the user action and information about the source element and target element involved in the action. “Stack” is the place to store Statements. The two stacks used in the TRG are redoStack and undoStack. “Element” serves to record information of either source element or target element. “Chain” is the place used to store Elements. Two kinds of Chains are used—Deleted Chain and Sequence Chain. “Unit” is for storing pointers of Elements. “XsltVariable” stores the generated XSLT variable names when there are frames in the source file.

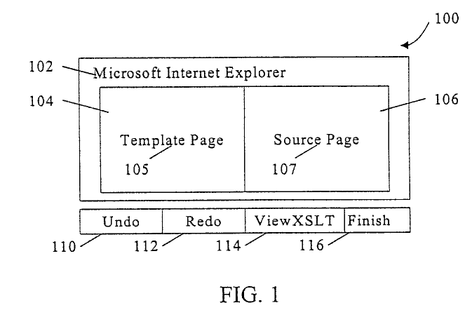

FIG. 1 shows a block diagram 100 of the representative user interface that appears in the client workstation. In consists of two frames, shown displayed on a browser 102 such as Microsoft Internet Explorer. The left frame 104 loads the template page 105. The right frame 106 loads the source page 107. Both the template page 105 and the source page 107 can contain frames. Particular identifiers (i.e., av_id, as representative of AdaptView Identifier) and paths (i.e., av_path, as representative of AdaptView Path) are added as attributes of each element in the two pages. For elements in the source page 107, the user can drag and drop the element into the template page 105. For elements in the template page 105, certain ones can be modified. For the revisable element, the user can move the position of the element in the template page and modify its attributes.

FIG. 1 further shows that there are at least 4 buttons (or click-through interface areas) in the user interface: “Undo” 110, “Redo” 112, “ViewXSLT” 114, and “Finish” 116. When the user clicks Undo, the latest action will be canceled. When the user clicks Redo, the latest undo action will be restored. When the user clicks ViewXSLT, the client session will request the server session to make the TRG generate XSLT according to user actions. After XSLT is generated, the server session will send XSLT to the client session which shows the XSLT to the user. When the user clicks Finish, it means that the user wants to finish customizing the current page. Thereafter, the client session will request the server session to generate XSLT and RDF for this page. The Resource Description Framework (RDF) is a general framework for how to describe any Internet resource such as a Web site and its content.

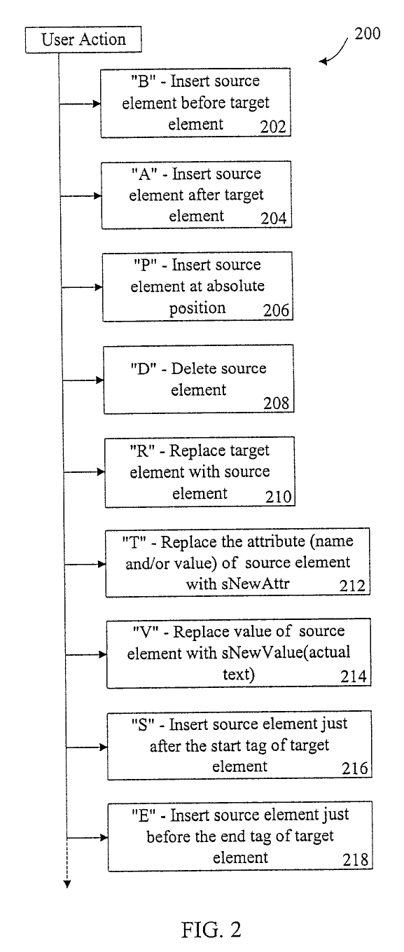

In the present example, there are nine representative user actions. FIG. 2 shows a block diagram 200 demonstrating the user selection of these possible actions as follows: “B” (202) is used to insert the source element before the target element; “A” (204) is used to insert the source element after the target element; “P” (206) is used to move the source element to an absolute position(x, y); “D” (208) is used to delete the source element. “R” (210) is used to replace the target element with the source element; “T” (212) is used to add/change/delete attributes of the source element; “V” (214) is used to replace the value of the source element with a value (“sNewText”), which is an actual text string); “S” (216) is used to insert the source element just after the start tag of the target element; “F” (218) is used to insert the source element just before the end of the target element. These actions might further be divided into two categories, namely position move (POS_MOV) including “B” “A” “D” “R” “S” and “E”; and position static (POS_STATIC) including “P” “T” and “V”.

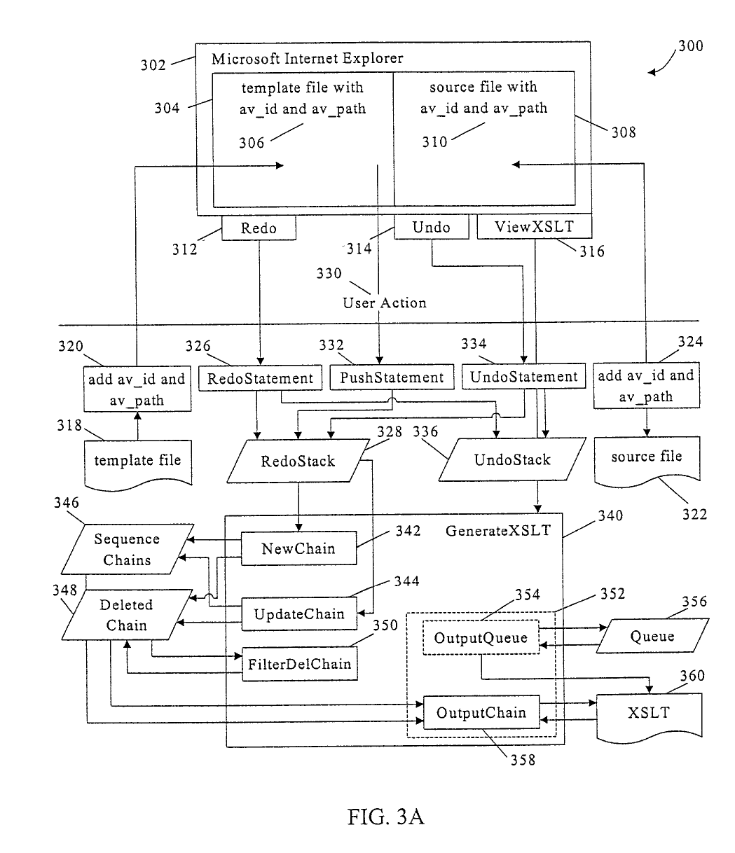

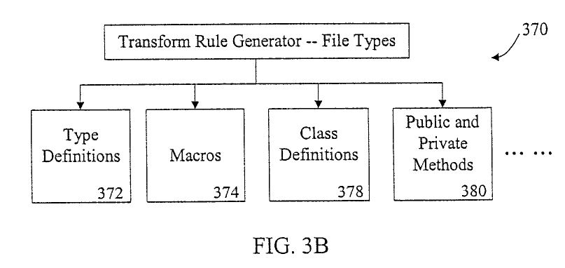

FIG. 3A next shows an representative block diagram 300 of the method for generating XSLT according to the present invention. While described briefly in terms of the overall diagram, the interacts will be described in more detail below. A browser (i.e., Microsoft Internet Explorer) 302 is shown displaying two frames. The left frame 304 displays the template file with the av_id and av_path information (306). The right frame 308 displays the source file with the av_id and av_path information (310). Buttons Redo 312, Undo 314, and ViewXSLT 316 are shown (with Finish omitted in this example). The template file 318 is shown having its particular av_id and av_path (320) added, with the result being 306. The source file 322 is shown having its particular av_id and av_path (324) added, with the result being 310.

The Redo button 312 leads to the functional block RedoStatement 326, which interacts with the redoStack 328. A User Action 330 (as per FIG. 2) is shown leading from the template file 306 to the functional block PushStatement 332, which interacts with the redoStack 328. The Undo button 314 leads to the functional block UndoStatement 334, which interacts with the undoStack 336. Further, RedoStatement 326 interacts with the undoStack 336, and UndoStatement 334 interacts with with redoStack 328.

The functional block GenerateXSLT 340 contains functions related to the aforementioned Chains. The redoStack 328 interacts with the functional block NewChain 342 and functional block UpdateChain 344. Both of these blocks 342, 344 interact with with the Chains types Sequence Chains 346 and Deleted Chain 348. The functional block FilterDelChain 350 is shown between the Deleted Chain 348 and the output functional blocks 352. An OutputQueue 354 is shown interacting with a Queue 356. The Deleted Chain and Sequence Chains 346 are shown interacting with the OutputChain 358. Both the OutputQueue 354 and the OutputChain 358 result in the generated XSLT 360.

The present embodiment of the TRG uses four representative types of files. First, “typedef.h” contains the definition of all the data structures used with the TRG. Second, “macro.h” contains certain macros used in the TRG. Third, “RuleGenerator.h” contains the class definition of the TRG. Fourth, “RuleGenerator.cpp” contains the definition of all public and private methods for the TRG. FIG. 3B shows a block diagram 370 of the functionality of such representative file types, which include type definitions 372, macros 374, class definitions 378, and public and private methods 380.

Regarding the first file type, while any of a variety of data structures might be used, the present embodiment uses the following structures, as defined and stored in the typedef.h file:

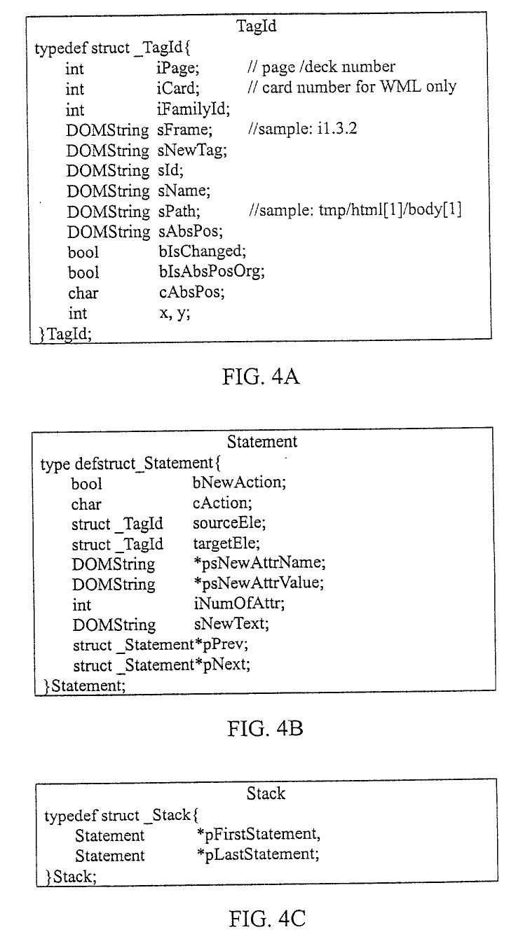

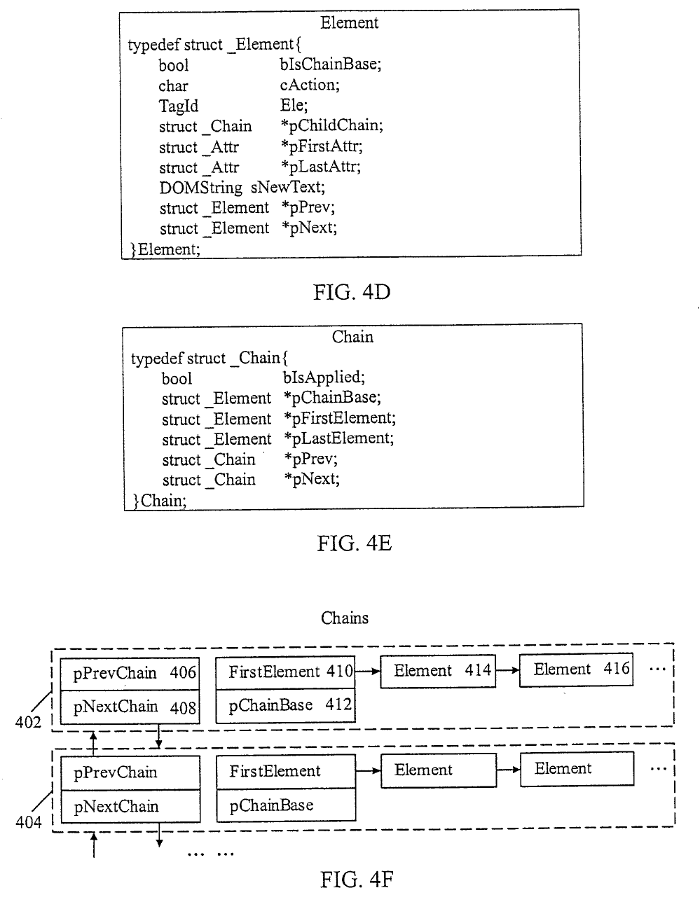

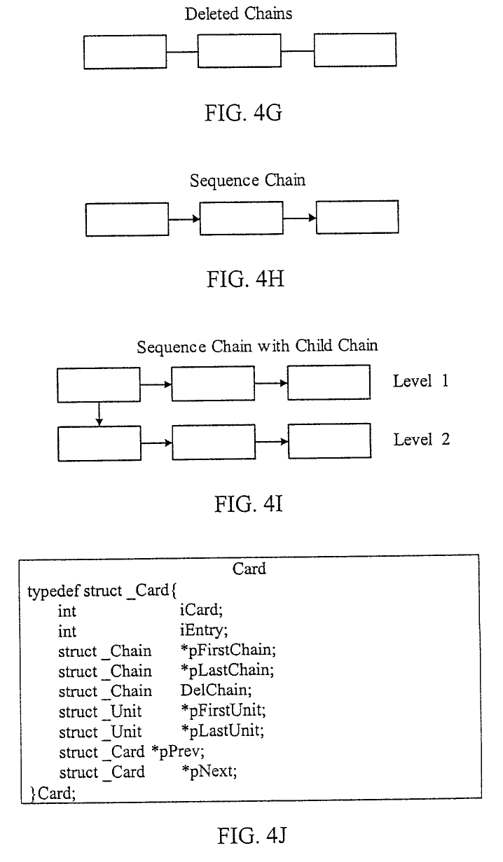

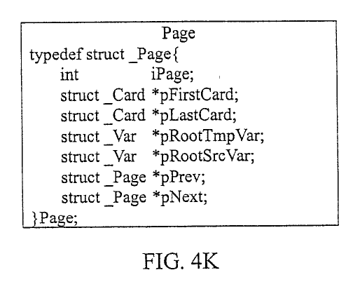

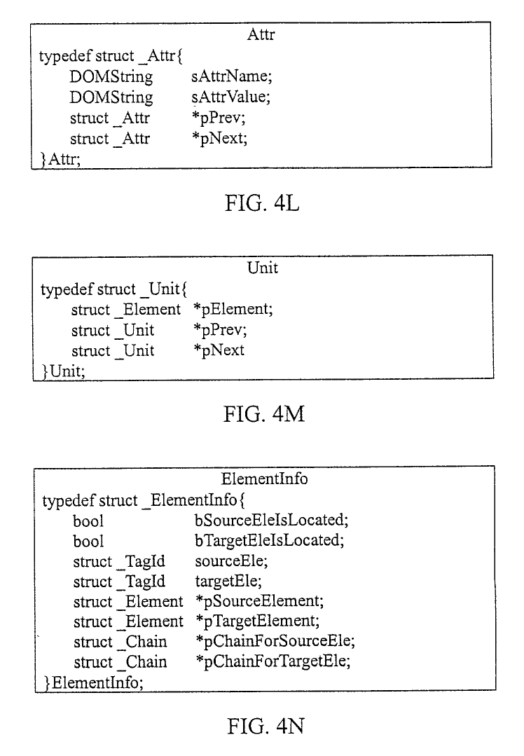

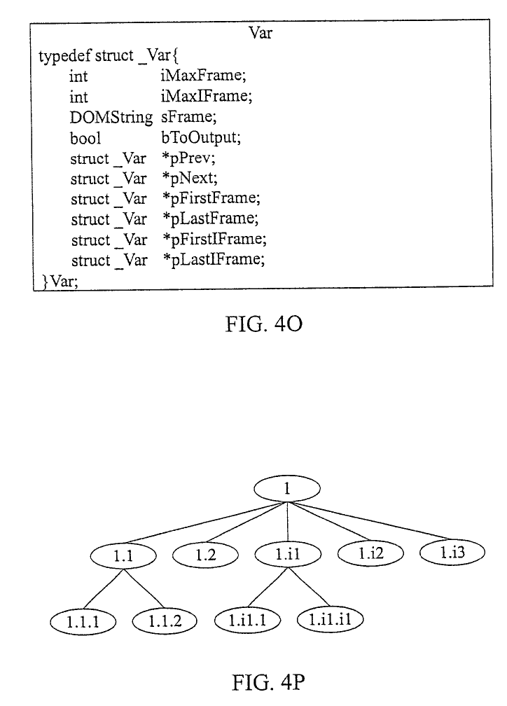

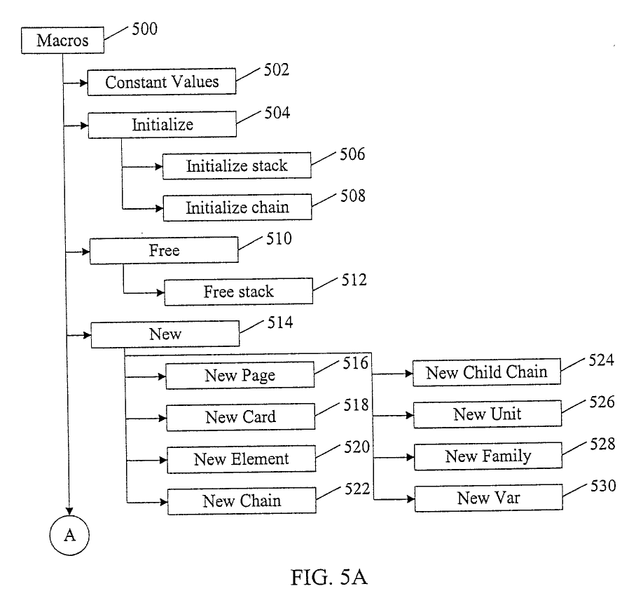

The structure TagId is shown defined with representative fields in FIG. 4A. The field iPage is used to indicate the page number to which the element belongs. Each page corresponds to a result XSLT. Each page contains one or more cards. When iPage is zero, the element is from the source file. The field iCard is used to indicate the card number to which the element belongs. The field iFamilyId is an identifier to indicate the copy number of an element. An element in the template file and source file may have more than one copy in one page. Different copies have different family ids. The field sFrame is used to store the frame information for an element. Elements in different frames correspond to different sFrames. The field sNewTag stores the tag name for a new element in the result page. A new element is generated by the user or other applications. It is not from the template file and source file. The field sId is used to store the value of the attribute id of an element. The field sName is used to store the value of the attribute name of an element. The field sPath is used to store the path of an element. The field bIsChanged is used to indicate whether the content of the element has been changed. Content includes the tag name, attributes, and value. This field is set by the Rule Generator. The field bIsAbsPosOrg is used to indicate whether the element original has absolute position, with a value from cAbsPos. This field is set by the Rule Generator. The field cAbsPos indicates the status of absolute position for the element after the user's last action on the element. It may have one of three values: NO_ABS_POS—the element has the relative position now; REF_ABS_POS—the element has absolute position and its position information is from the other element; REAL_ABS_POS—the element has absolute position and it position information is indicated by the field x and y in this structure. Note that when “P” is operated on an element, its cAbsPos is set to REAL_ABS_POS. The fields x, y store the absolute position of the element, if it has an absolute position. Note that only two fields (bIsChanged and bIsAbsPosOrg) are set by the Rule Generator. Other fields are set by the caller.

FIG. 4B next shows the type definition of the structure Statement. Statement is used to store information about user actions. Each action corresponds to one statement. Statements are stored in the redoStack and undoStack. The Statement definition includes representative fields, with the field bNewAction indicating whether this statement is a new user action in the user interface in the client session. When this field is set to true, then the statement corresponds to a new user action in the user interface, or the first of user actions divided from a user action in a user interface. When this field is false, then the statement corresponds to other user actions divided from a user action in the user interface. The field cAction is used to record the user action. The fields sourceEle and targetEle are the two elements involved in the user action. The fields psNewAttrName and psNewAttrValue are two arrays used to store the set of name and value of attributes of the element modified by the user. The field iNumOfAttr indicates the length of the aforementioned arrays. The field sNewText is used to store the new text of the element modified by the user. The fields pPrev and pNext represent two statement pointers to the previous and next statements.

FIG. 4C shows the type definition for the structure Stack, which is used to store Statements. Stack simply contains two pointers. The pointer pFirstStatement is a statement pointer to the bottom of the stack. It is set when the first statement is pushed into the stack. The pointer pLastStatement is a statement pointer to the top of the stack. It is updated by the public method PushStatement, RedoStatement, and UndoStatement.

FIG. 4D shows the type definition for the structure Element, which is used to store information about an element and modifications to the element, such as its value, attribute, or child chain. In the descriptions below, “Element” “Element” and “element” have different meanings. “Element” represents the instance of this structure. Element represents this structure. Finally element represents the element in the source file or template file. Moreover, Element(X) represents an Element whose content is from a TagId X. The field cAction records the user action. The field Ele stores the information about the element. The field pChildChain is a chain pointer to the child chain of the Element. When the user action is “S” or “E” and pChildChain is NULL, a child chain will be generated for the Element. When the field is NULL, the Element has no child chain. The fields pFirstAttr and pLastAttr are two structure Attr pointers to the head and tail of the changed attribute list. The field sNewText stores the new text of Element. The fields pPrev and pNext are two Element pointers to the previous and next Elements.

FIG. 4E next shows a representative type definition of the structure Chain, which stores Elements. All Elements in the same chain lead to output sibling elements in the result page. The field bIsApplied indicates whether this chain has bee applied to output XSLT. The field pChainBase is an Element pointer to the chain base. Each chain except child chains and Deleted Chain has a chain base that indicates the reference position of the chain. Note that the Deleted Chain and the child chain do not have a chain base (i.e., pChainBase is NULL). The fields pFirstElement and pLastElement are two Element pointers to the first and last Elements in the chain. The fields pPrev and pNext are two Chain pointers to the previous and next chains.

Accordingly, FIG. 4F shows a block diagram of representative Chains in relation to one another. A first Chain 402 and second Chain 404 each show instances of the pointers pPrevChain 406 and pNextChain 408. The FirstElement 410 includes a pointer to the pChainBase 412, which is the chain base of the chain 402. Elements 414, 416, and so forth are linked sequentially after the FirstElement 410.

FIGS. 4G, 4H, and 4I show further examples of Chains. FIG. 4G shows a Deleted Chain, which is an unordered chain. Elements in the Deleted Chain have no relative position to each other. In the Deleted Chain, the field pChainBase is NULL. Each page has a Deleted Chain. Moreover, when statements are analyzed from the bottom to the top by public method GenerateXSLT, Element(sourceEle), whose cAction belongs to POS_MOV, will be put into the Deleted Chain. After analyzation of all the statements, the deleted chains in all the pages will be filtered by private method FilterDelChain (350 in FIG. 3). Filtering is further described below.

FIG. 4H shows a Sequence Chain, which is an ordered chain. The field “Chain *pNext” in one Element is not only a pointer to the next Element, but also shows that this Element shall occur before the next Element in the result page.

FIG. 4I shows an example of a Sequence Chain with a Child Chain. Via the field pChildChain, an Element may have a child chain which is an instance of a structure Chain. In this instance, the chain has at least one level of Elements. From the ancestors to descendants, the level is from 1 to N. FIG. 4I shows an instance of Level 1 and Level 2 Elements.

FIG. 4J shows a representative type definition of the structure Card, which stores chains and a queue of units. The field iCard indicates the card number of the card. The fields pFirstChain and pLastChain are two pointers to the first and last sequence chains in the card. Each card may contain more than one of the Sequence Chains. The field DelChain stores the deleted Elements. The fields pFirstUnit and pLastUnit are two pointers to the first and last units. A queue of Elements may be setup for each card if changed elements exist. These two fields point to the head and tail of the queue. The fields pPrev and pNext are two card pointers to the previous and next cards.

FIG. 4K next shows a representative type definition of the structure Page. This structure stores cards and the root for variables, i.e., XSLT variables for supporting multi-frame. The field iPage indicates the page number of the page. The fields pFirstCard and pLastCard are two card pointers to the first and last card. Each page may contain more than one card. The fields pRootTmpVar and pRootSrcVar are two Var pointers to the root of the Var trees for the template file and the source file. A private method ParseFrame can be used to scan all chains in a page to set up two Var trees for all Elements in the page, then output the Var trees with the priority of depth. The fields pPrev and pNext are two page pointers to the previous and next page.

FIG. 4L shows a representative type definition of the structure Attr. Attr stores the name and value of changed attributes of the element. In this instance, “changed” means that an element has been operated on by “add/edit/delete.” The field sAttrName stores the name of the changed attribute of the element. The field sAttrValue stores the value of the changed attribute of the element. If the length of sAttrValue=0, then the corresponding attributes are deleted.

FIG. 4M next shows a representative type definition of the structure Unit. Unit stores the pointer to an Element whose cAction is not “P” “T” and “V”. Each card has a queue of Unit. When sequence chains in a card are scanned to output XSLT, the unchanged Elements are wrapped by Unit and appended to the queue. After scanning sequence chains with chain base and deleted chain in a card, the queue will be scanned and XSLT will be output for Elements in the queue. Because Elements may have a child chain, new changed Elements will be appended to the queue as the queue is being scanned. When a unit is output, it will be deleted from the queue. XLST will be output until the queue is empty (i.e., it does not contain any Unit). The field pElement is an Element pointer to a changed Element. The fields pPrev and pNext are two Unit pointers to the previous and next unit.

FIG. 4N next shows a representative type definition for the structure Elementinfo. ElementInfo stores the information about the sourceEle and targetEle in a statement. It is used to check whether sourceEle and targetEle are in the existing sequence chains. The fields bSourceEleIsLocated and bTargetEleIsLocated are used to indicate whether sourceEle and targetEle are found in existing sequence chains (with true=found; false=not found yet). The fields sourceEle and targetEle are two TagIds, which are copied from the same field of the statement. The fields pSourceElement and pTargetElement are two Element pointers to the found Element(sourceEle) and Element(targetEle). When pSourceElement is NULL, it means that the sourceEle has not been found in sequence chains or sourceEle is from the source file. When pTargetElement is NULL, it means that the targetEle is not found in the sequence chains. The fields pChainForSourceEle and pChainForTargetEle are two Chain pointers to the chains containing Element(sourceEle) and Element(targetEle) respectively. The two pointers may be the same one. Note that when pSourceElement is NULL, pChainForSourceEle must be NULL; and when pTargetElement is NULL, pChainForTargetEle must be NULL.

FIG. 4O next shows a representative type definition of the structure XSLT variable. The structure Var is used to construct a Var tree, and stores the information about its siblings and children. The field iMaxFrame is used to indicate the maximum number of frames the Var contains. The field iMaxIFrame is used to indicate the maximum number of iframes the Var contains. The field sFrame stores the information about the frame. This field has the same meaning of the field sFrame in the structure TagId. The field bToOutput is used to indicate whether the XSLT variable corresponding to this Var will be output by the private method OutputVar. The fields pPrev and pNext are two Var pointers to the previous and next sibling Vars. The fields pFirstFrame and pLastFrame are two Var pointers to the first and last child frame. The fields pFirstIFrame and pLastIFrame are two Var pointers to the first and last child iframe.

FIG. 4P next shows a sample Var tree for a source file. The sequence levels for each frame, iframe, and their respective children can be through three example levels.

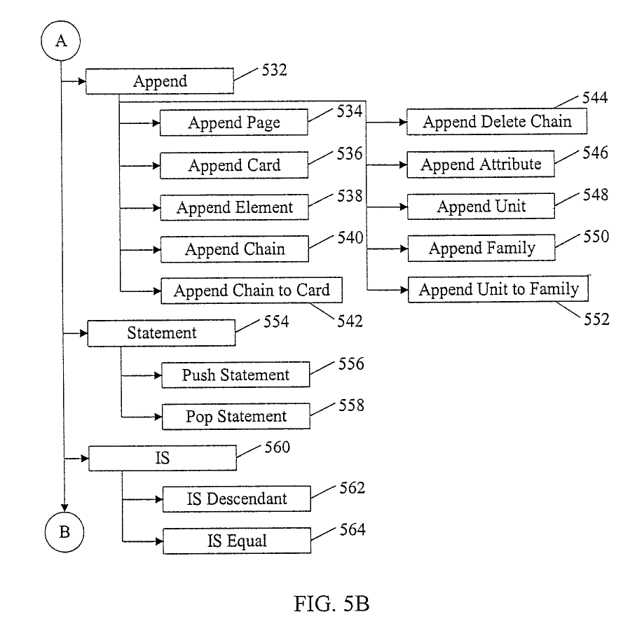

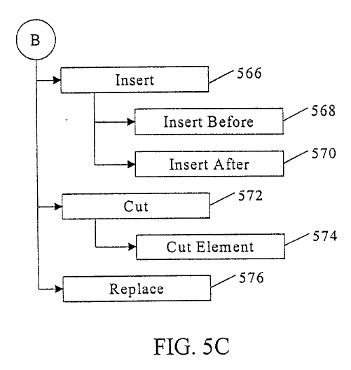

The second file type described in relation to FIG. 3B is one for storing macros. In the present embodiment, macros are defined and stored in the file macro.h. While any of a Variety of macros 500 might be defined and used, FIGS. 5A-5C provide examples. The Constant Values 502 corresponds to the constant values. Initialize 504 includes a routine for initializing the stack 506 and initializing the chain 508. Free 510 includes a routine to free the stack 512. New 514 includes routines to create a New Page 516, New Card 518, New Element 520, New Chain 522, New Child Chain 524, New Unit 526, New Family 528, and New Var 530. Append 532 includes routines to Append Page 534, Append Card 536, Append Element 538, Append Chain 540, Append Chain to Card 542, Append Delete Chain 544, Append Attribute 546, Append Unit 548, Append Family 550, Append Unit to Family 552. Statement 554 includes a routine 556 for pushing a statement onto the stack, and a routine 558 for popping a statement from the stack. Decisional routines are shown as “IS” 560. One such routine IS Descendant 562 is used to decide whether element Ele_2 is the descendant of element Ele_1. Another such routine IS Equal 564 is used to decide whether Element Ele_2 equals Element Ele_1. Insert 566 involves two pointers p1 and p2, and includes the routines Insert Before 568 and Insert After 570. The routine Cut 572 allows for cutting of elements via the routine Cut Element 574. The routine Replace 576 provides for replacement editting tasks. The macros are more fully defined in Appendix A (pages A1-A9).

The third representative file type, shown as 378 in FIG. 3B, stores the class definitions for the Rule Generator. Appendix B shows an example of the class “RuleGenerator” as used with the present embodiment.

The fourth representative file type, shown as 380 in FIG. 3B, stores the public and private member information, and the public and private method information.

Public Members. In the present embodiment, only one public member—PageRule—is used for page alignment, and the like.

Private Members. The private members include two stack members: redoStack and undoStack. A statement is pushed into redoStack when the user makes a new action or clicks the “Redo” button in the User Interface (UI). In the latter case, the top statement in the undoStack is popped out. A statement is pushed into the undoStack when the user clicks the “Undo” button in the UI. At the same time, the top statement in the redoStack is popped out. Accordingly, the member redoStack corresponds with the methods: PushStatement, RedoStatement, UndoStatement, NewChain, and UpdateChain. The member undoStack corresponds with the methods: RedoStatement and UndoStatement.

The first sequence Chain with a chain base is pointed to by the private member m_pFirstChain. The last Sequence Chain with a chain base is pointed to by the private member m_pLastChain. The member m_pDelChain corresponds with the method Generate XSLT. The member m_pFirstChain corresponds with the method NewChain, and GenerateXSLT. The member m_pLastChain corresponds to with the method NewChain, UpdateChain, and GenerateXSLT.

There are two boolean members: m_bCanRedo and m_bCanUndo. These two boolean members are initially set to false. They are updated by the public method PushStatement, RedoStatement, and UndoStatement. The public method RedoStatement returns m_bCanRedo to the caller to tell whether the user can further redo or not. The public method UndoStatement returns m_bCanUndo to the caller to tell whether the user can further undo or not.

Public Methods. While any of a Variety of public methods might be used, the preferred embodiment uses the following:

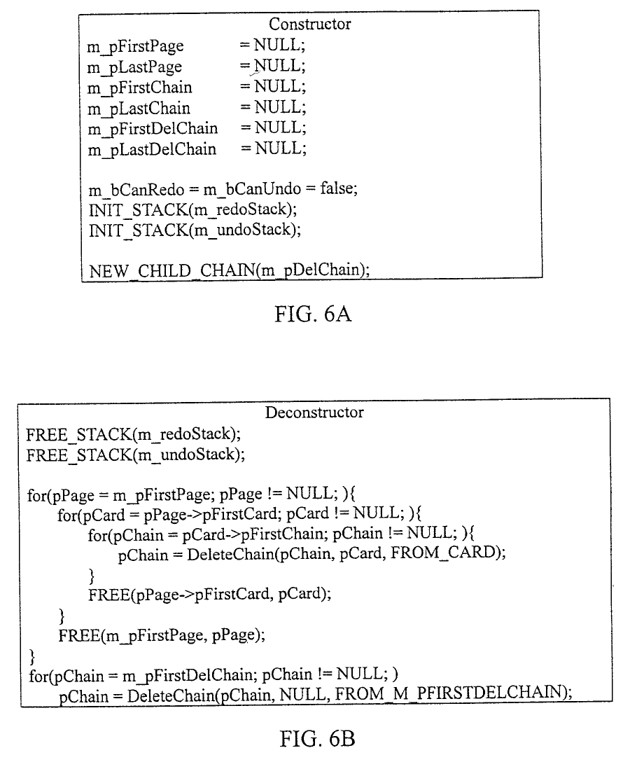

Constructor, which is used to initialize the instance of TRG. Representative pseudo code is shown in FIG. 6A.

Deconstructor, which is used to free allocated memory. Representative pseudo code is shown in FIG. 6B.

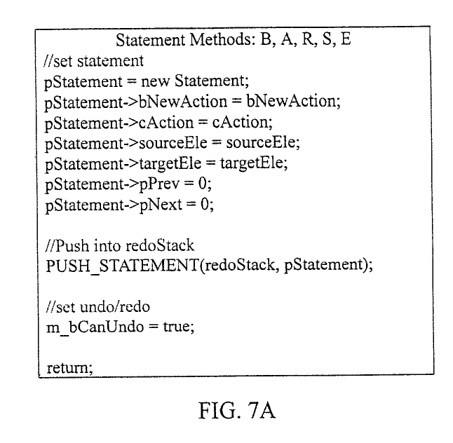

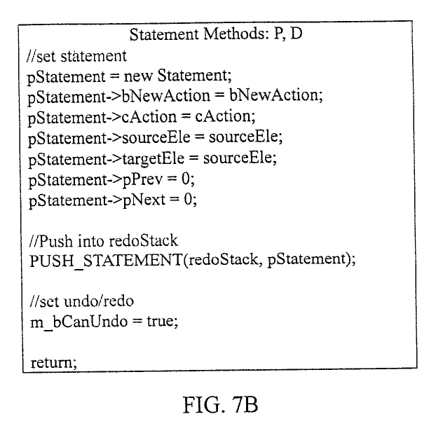

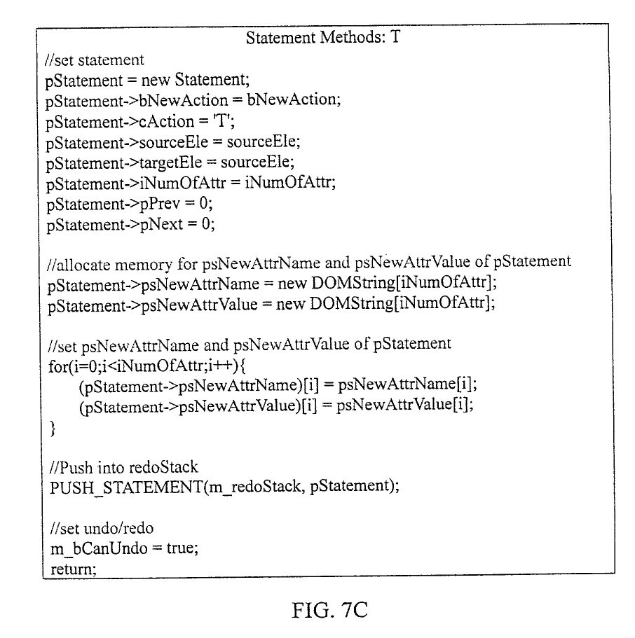

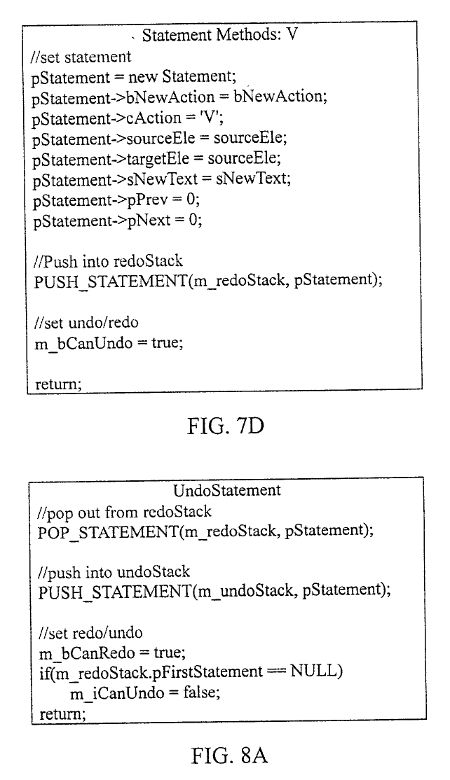

Statement methods include a PushStatement, which receives data from the caller and pushes a new statement into the redoStack. Different forms of PushStatement are called according to different user actions. The user actions “B” “A” “R” “S” and “E” utilize the form: PushStatement (char cAction, TagId sourceEle, TagId targetEle, bool bNewAction). The character cAction is the user action. TagId sourceEle is the element to be moved. TagId targetEle is the element to be replaced or to be used as the reference element. The boolean bNewAction is the status of whether this statement will represent a new action. Representative pseudo code is shown in FIG. 7A.

The user actions “P” and “D” utilize the form: PushStatement(char cAction, TagId sourceEle. bool bNewAction), wherein TagId sourceEle in this instance is the element to be moved to an absolute position, or to be deleted. Representative pseudo code is shown in FIG. 7B.

The user action “T” utilizes the form: PushStatement(TagId sourceEle, DOMString psNewAttrName[ ], DOMString psNewAttrValue[ ], int iNumOfAttr, bool bNewAction). TagId sourceEle represents the element whose attributes are modified. The first DOMString array is for storing the name of modified attributes. The second DOMString array is for storing the value of modified attributes. The integer parameter is the size of the above two arrays, both being the same size. The boolean is the status of whether this statement will represent a new user action. Representative pseudo code is shown in FIG. 7C.

The user action “V” utilizes the form: PushStatement(TagId sourceEle, DOMString sNewText, bool bNewAction). The first parameter is the element to be replaced. The second parameter is the new value of the element. The boolean is the status of whether this statement will represent a new user action. Representative pseudo code is shown in FIG. 7D.

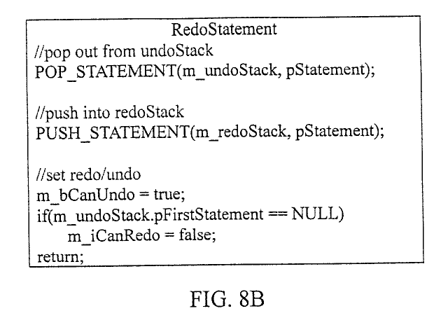

The UndoStatement pops a statement from the redoStack and pushes in onto the undoStack. Representative pseudo code is shown in FIG. 8A. The RedoStatement pops a statement from the redoStack and pushes it into the undoStack. Representative pseudo code is shown in FIG. 8B.

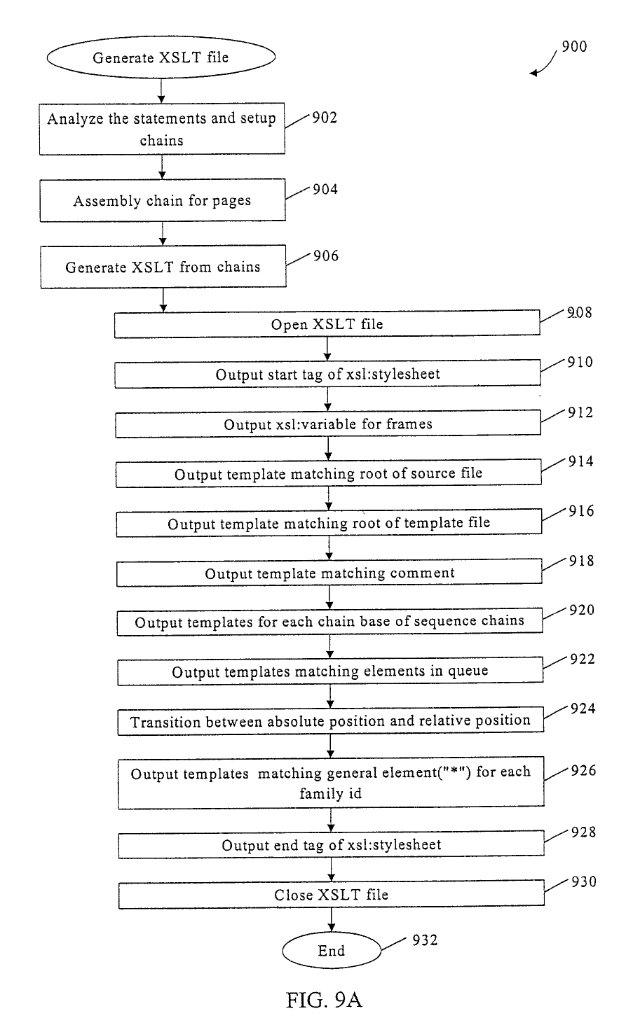

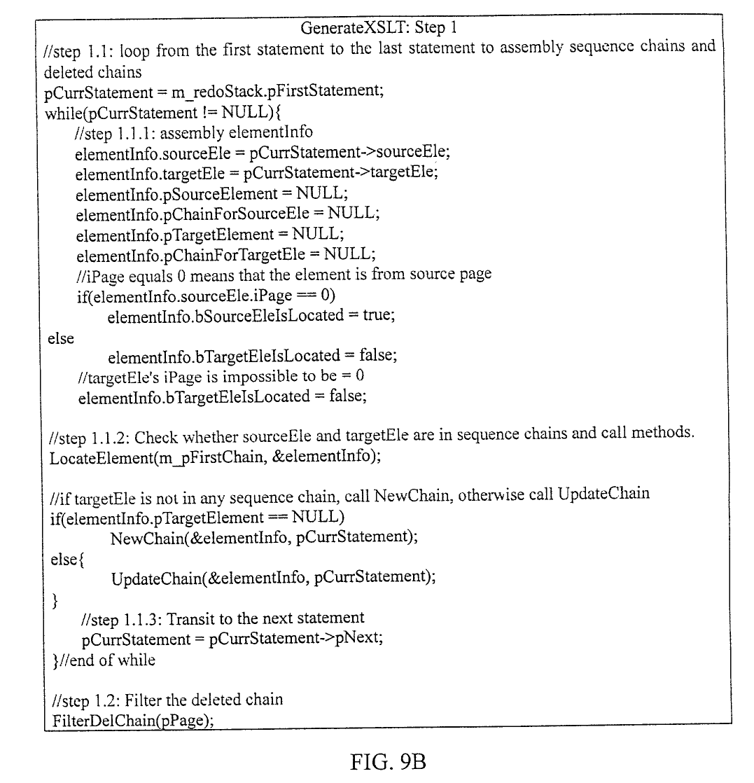

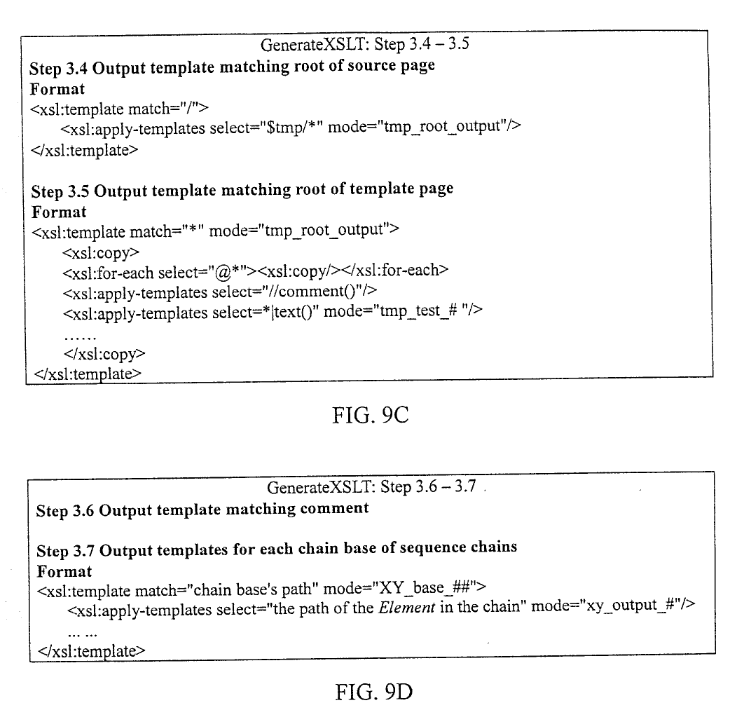

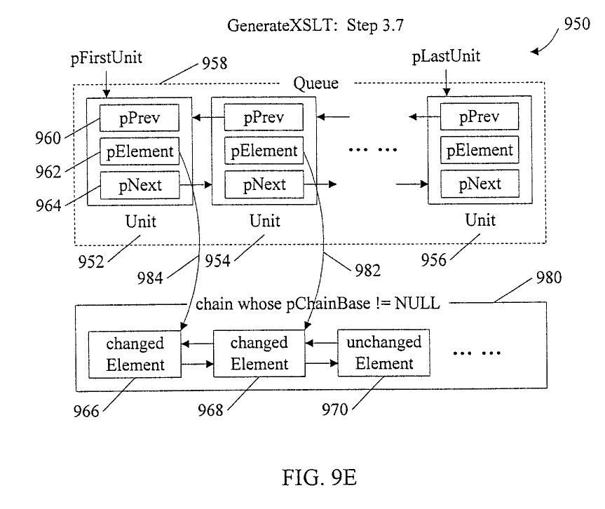

The XSLT member is next described. The method GenerateXSLT generates XSLT according to the statements in the redoStack. FIG. 9A shows a flow diagram 900 of certain representative steps associated with this method. Step 1 (902) involves analyzing the statements and setup chains. Representative pseudo code is shown in FIG. 9B. Step 2 (904) involves the formation of assembly chains for pages. Sequence chains pointed to by m_pFirstChain are assembled to pages and cards according to iPage and iCard in the chain base. Each page may contain more than one card, and each card may contain more than one sequence chain. Elements in the deleted chain pointed to by m_pDelChain are assembled to several deleted chains according to iFamilyId in Elements. Each page corresponds to an XSLT file. As a result, the outermost loop is for pages. In the loop for a page, the procedure for generating XSLT follows the steps shown as Open XSLT file 908; Output start tag of XSL stylesheet 910; and Output XSLT variable for frames 912. Here the private method ParseFrame is called to build a Var tree for frame information of all operated elements. Thereafter the private method OutputVar is called to output the XSLT variable for those frames. The next step 914 is used to output the template matching root of the source file. Step 916 is used to output the matching root of the template file. Representative pseudo code is shown in FIG. 9C.

Step 918 next shows outputting the template matching comment, and step 920 shows outputting templates for each chain base of the sequence of chains. Representative pseudo code is shown in FIG. 9D. X represents “tmp” or “src” when the chain base is from the template file or the source file. Y is the field sFrame of the structure TagId for the chain base. ## is the family id of the chain base. “x” represents “tmp” or “src” when the element is from the template file or the source file. “y” is the field sFrame of the structure TagId for the Element in the chain. # represents the family id of the Elements in the chain.

There are generally two cases for each Element in the chain: (1) the Element is unchanged. In such a case, no specific template shall be written for this Element. (2) the Element is changed. In this case, the Element is appended to the queue, wherein the queue consists of units. Each unit contains an Element pointer. As a result, the queue is actually a list of Element pointers.

The diagram 950 in FIG. 9E serves to demonstrate this case. Three Units 952, 954, and 956 are shown in the queue 958. Each Unit is shown to include a pointer pPrev 960, which points to the previous Unit, and pNext 964 which points to the next Unit. The pointer pElement points to some form of the Element. A pointer pFirstUnit points to Unit 952, and a pointer pLastUnit points to the Unit 956. Below, a chain 980 is shown whose pChainBase is not NULL, and which contains representative changed Elements 966 and 968, and unchanged Elements 970. The arc arrow(s) 982 indicate that the pointer pElement (962) is equal to the Element pointer to the changed Element 966.

Step 922 next serves to output templates that match Elements in the queue. If Elements in the queue are all changed, then there may be one (or more) of the following cases: (1) the attributes are changed; (2) the value (or the text) is changed; and (3) other elements are inserted to be the children—for example, another element is inserted after the start tag of the current element (i.e., the user action is “S”).

Step 924 next shows the process of transition between the absolute position and the relative position. Representative examples are incorporated by reference from the provisional patent application, referred to above. Step 926 shows the process of outputting templates matching the general element “*” for each family id. Step 928 shows the processing of outputting the end tag of the XSL stylesheet. Step 930 shows the process of closing the XSLT file. Thereafter, the routine ends with 932.

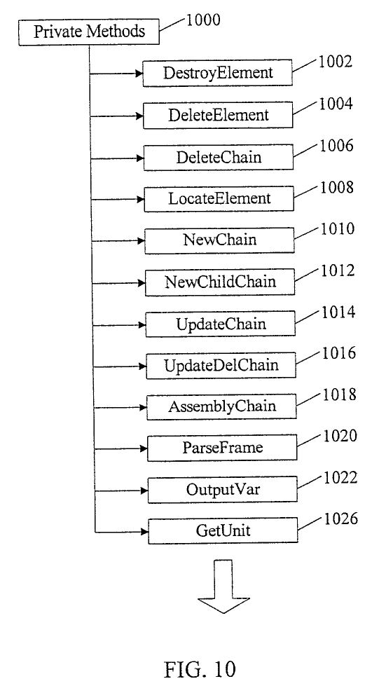

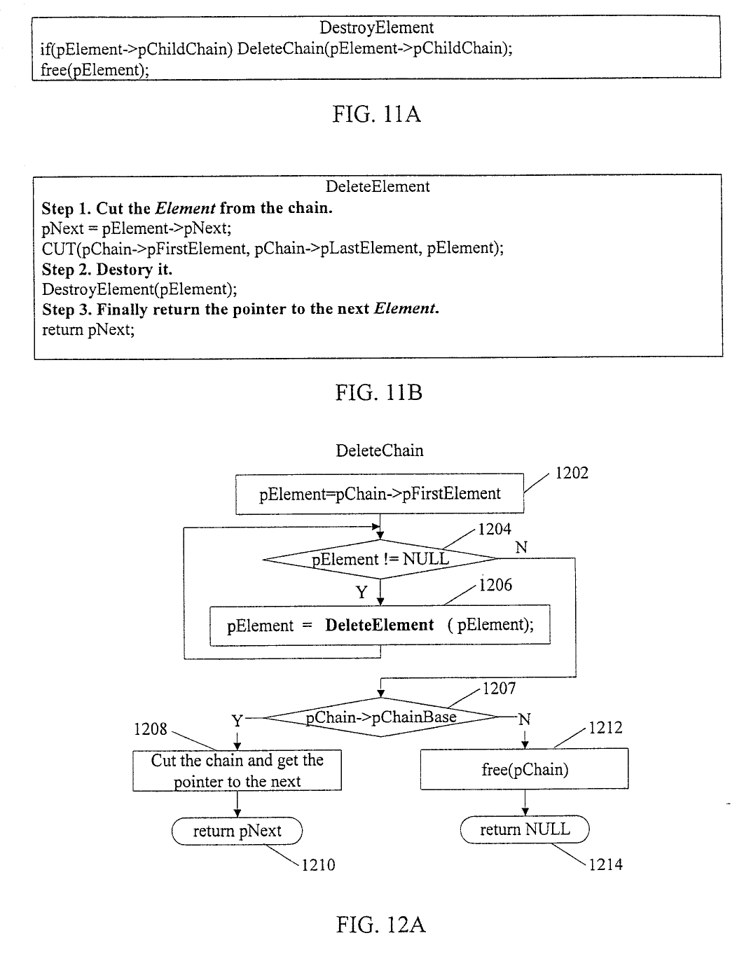

Private and public methods. Methods can exist either publically or privately, depending upon how the method should be shared. Examples of such methods 1000 are included in FIG. 10, and further discussed below. Further details and definitions of the representative parameters can be found in the incorporated and referenced provisional application.

The method “DestroyElement” 1002 serves to destroy an Element which has been cut from the chain. Representative pseudo code (and/or call statements) for this method are referred to in FIG. 11A.

The method “DeleteElement” 1004 serves to delete an Element from the chain. Steps include: (1) cutting the Element from the chain, (2) destroying it, and (3) returning a pointer to the next Element. Representative pseudo code (and/or call statements) for this method are referred to in FIG. 11B.

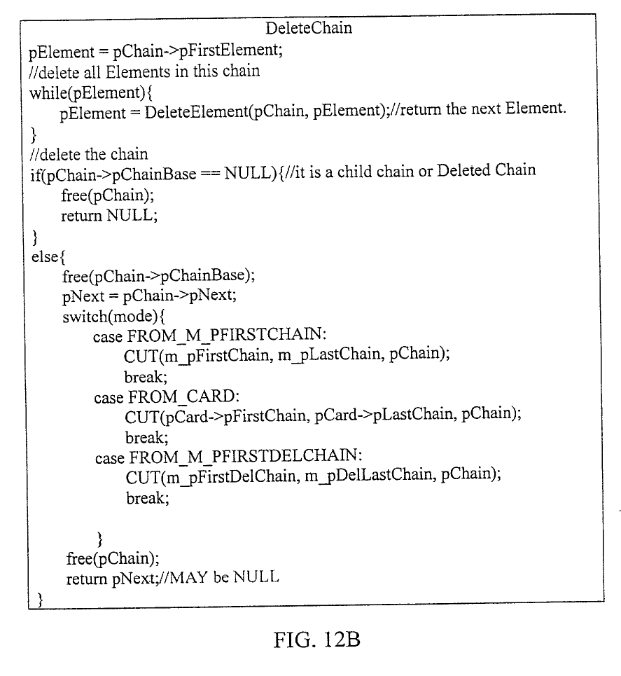

The method “DeleteChain” 1006 serves to delete a chain from a chain list. A representative flow chart is shown in FIG. 12A, with corresponding pseudocode shown in FIG. 12B. In step 1202, the element pointer is set to the first element in the chain. In step 1204, if this pointer value is NULL, then the DeleteElement method is called in step 1206. If the pointer is not NULL, then the routine loops back to call private method DeleteElement, otherwise it checks (1207) whether pChainBase is NULL. If yes, then step 1208 shows the process of cutting the chain and getting the pointer to the next Element, and thereafter returning the pointer in step 1210. If no, then the pointer to the Chain is freed (1212), and a NULL value 1214 is returned.

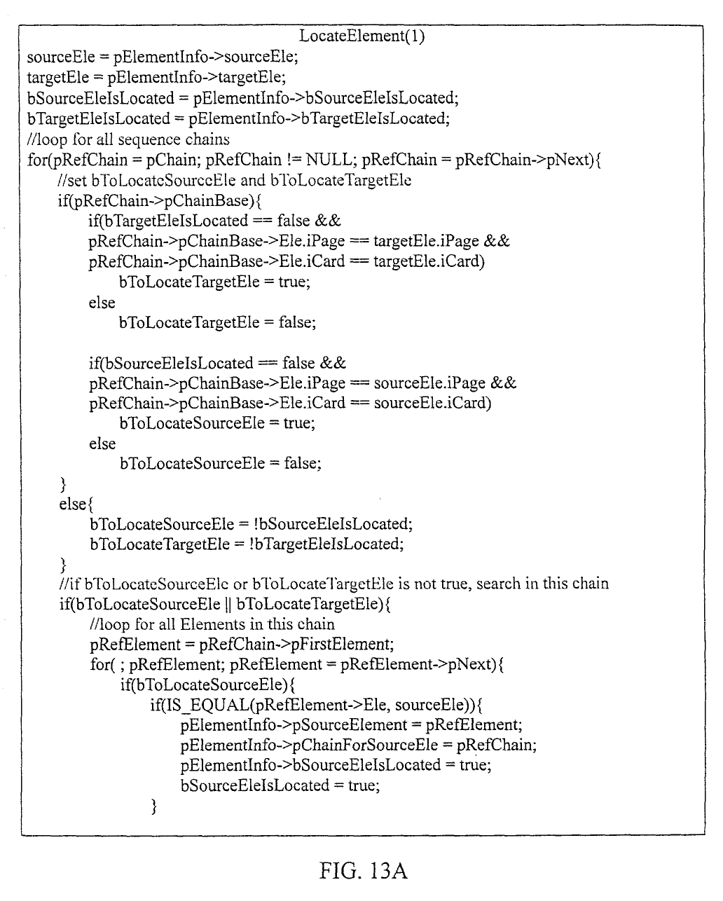

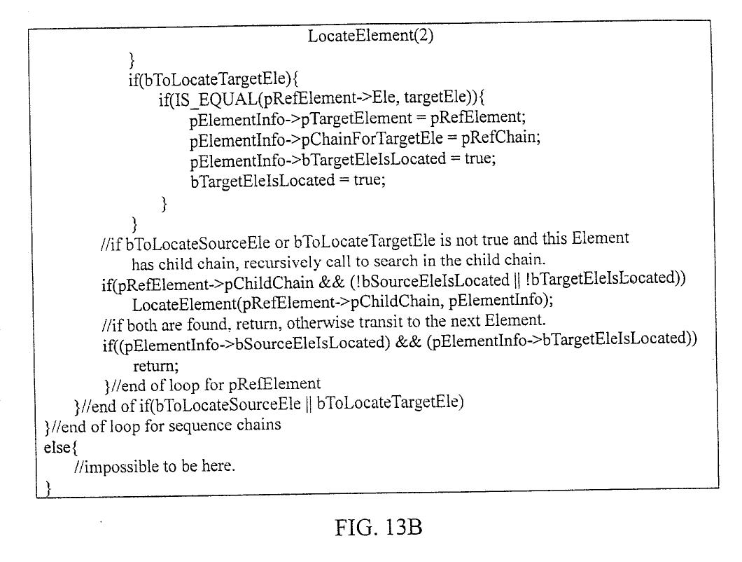

The method “LocateElement” 1008 serves to locate Elements which have the same id or path as that of TagId in pElementInfo. This method searches (i.e., compares the iFamilyId and sPath) of the sourceEle and targetEle in all Sequence Chains. If the Element is found, then fields are set in the pointer pElementInfo. Representative pseudocode is shown in FIGS. 13A-13B.

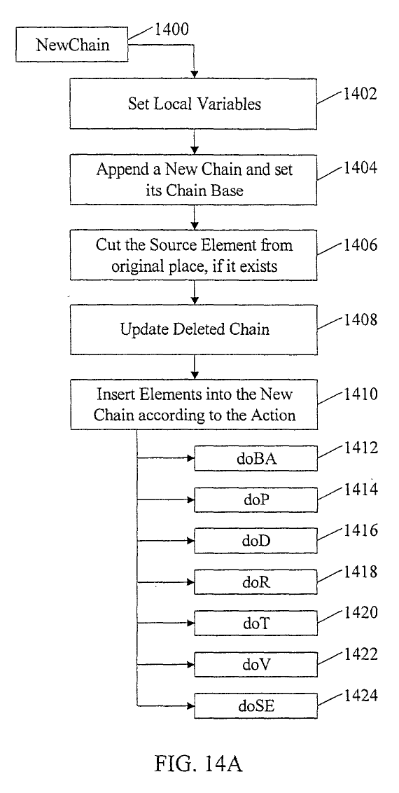

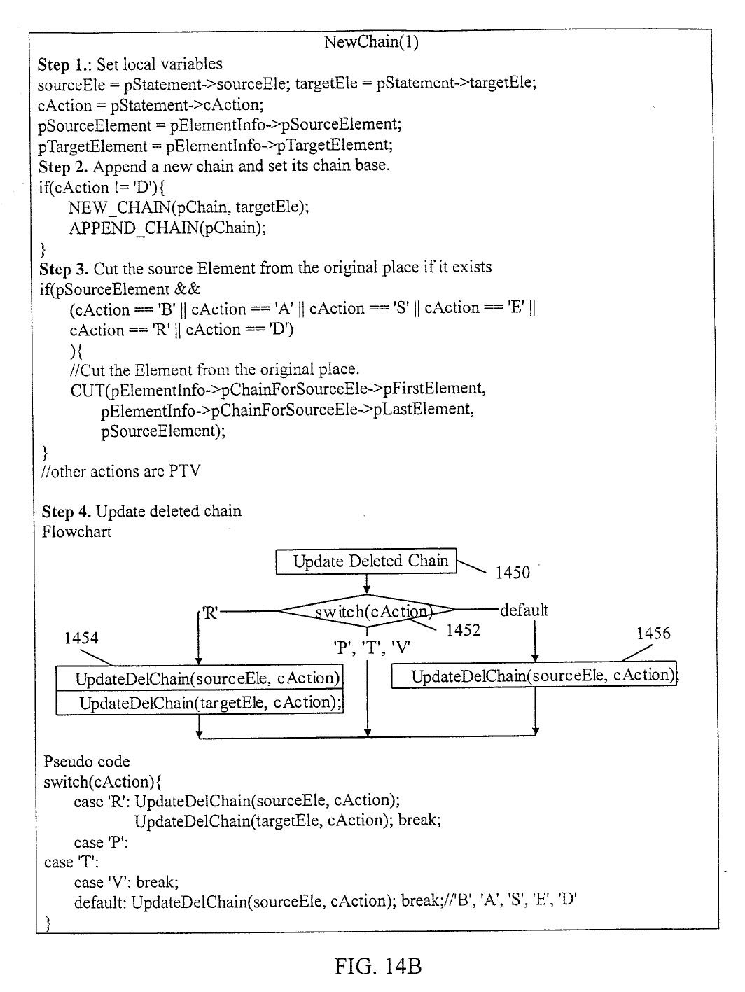

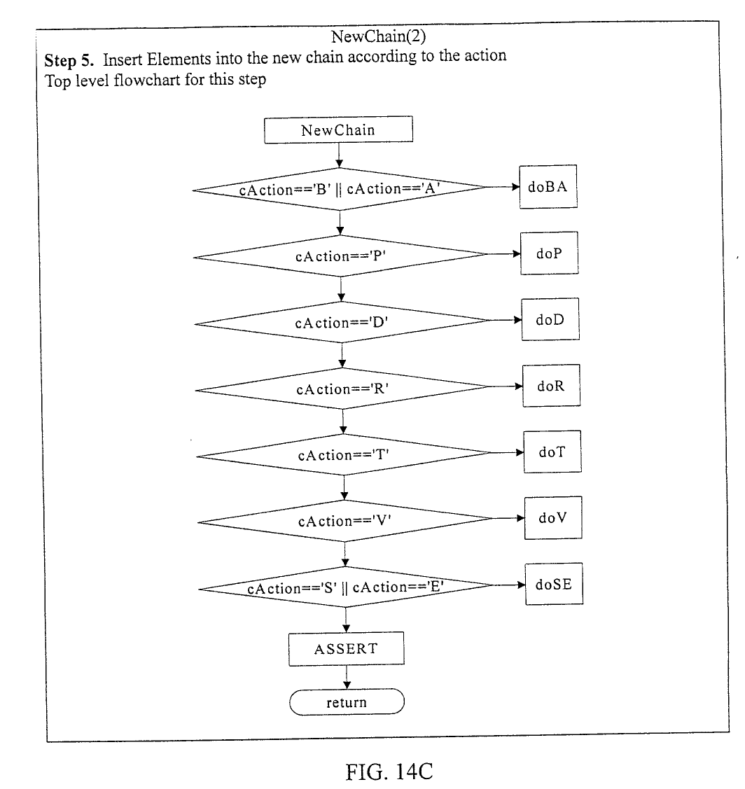

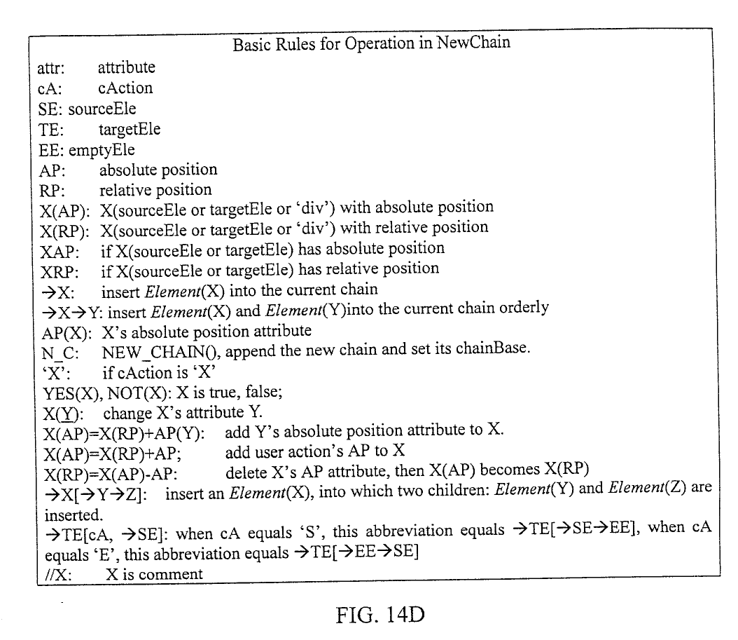

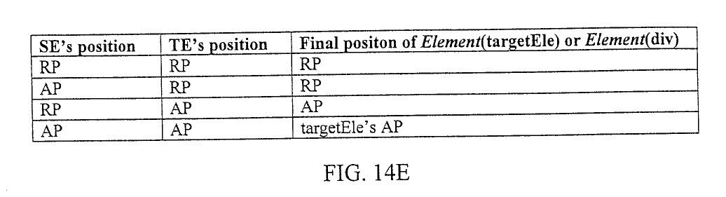

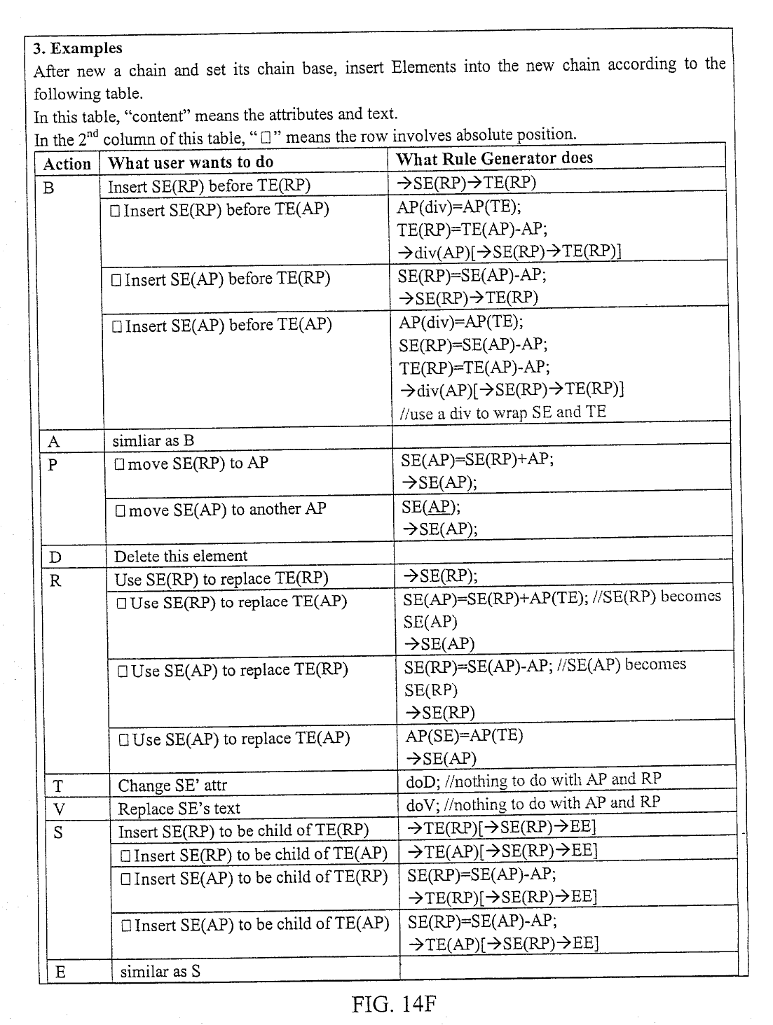

The method “NewChain” 1010 serves to append a new chain, set its chain base and the associated Elements. Representative steps associated with this element are shown in FIG. 14A. The steps and associated flowcharts are further detailed in association with FIGS. 14B-14C. Referring to the figures collectively, the New Chain 1400 first utilizes a step 1402 for setting the local variables. The next step 1404 is used to append a new chain and set its chain base. The next step 1406 is used to cut the source Element for the original place, if it exists. Step 1408 shows the process of updating the deleted chain. FIG. 14B additionally shows an associated flowchart and pseudocode, starting with block 1450 (Update Deleted Chain). A “switch” routine 1452 tests the value the user action (cAction). If “R” is selected, then the routine UpdateDelChain 1454 is called for both the sourceEle and targetEle. If “P” “T” or “V” are selected by the user, then control is passed on through the routine. The default is to call UpdateDelChain 1456 for the sourceEle.

The next step 1410 is to insert the Elements into the new chain, according to the action selected by the user. As detailed above, the representative actions include doBA 1412, doP 1414, doD 1416, doR 1418, doT 1420, doV 1422, and doSE 1424. As further shown in the flowchart on FIG. 14C, these routines are based upon the user selections “B” “A” “P” “D” “R” “T” “V” “S” and “E”.

The tables shown in FIGS. 14D, 14E, and 14F provide a summary of representative actions in terms of defined operations. FIG. 14D shows certain basic rules for operation with the private method NewChain. FIG. 14E shows the handling of different positions. The sourceEle and targetEle may have different kinds of positions: AP (Absolute position) or RP (Relative Position). For example, sourceEle has AP but targetEle has RP. When the action involves sourceEle and targetEle, the targetEle's position is used for the final position. FIG. 14F shows examples, based upon the Action, What the user wants to do, and What the Rule Generator will do. In particular, after establishing a new chain and the setting of its chain base, Elements are inserted into the new chain according to the table in FIG. 14F. In the table, “content” means the attributes and text. The downward arrow means that the row involves absolute position.

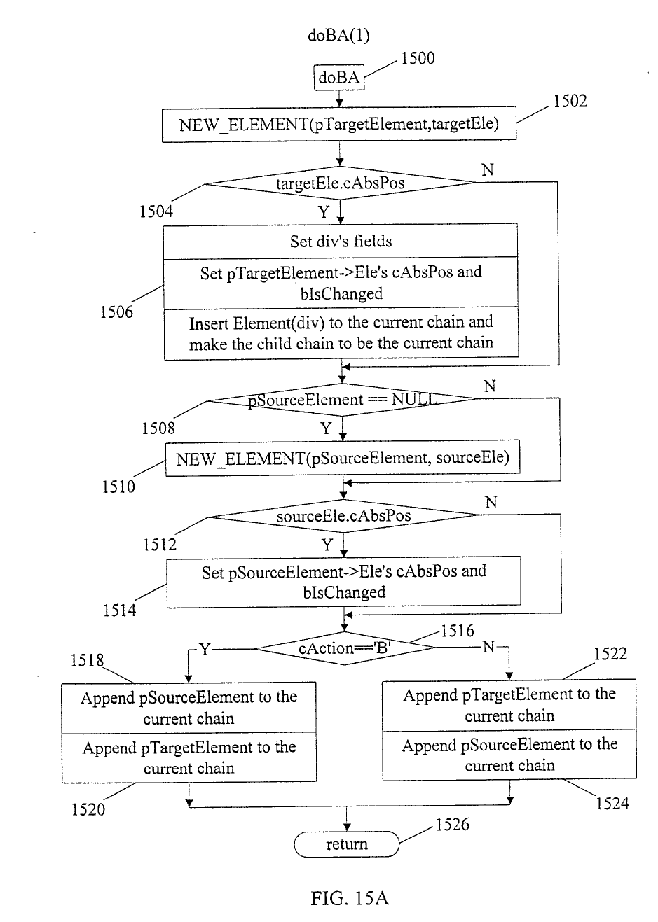

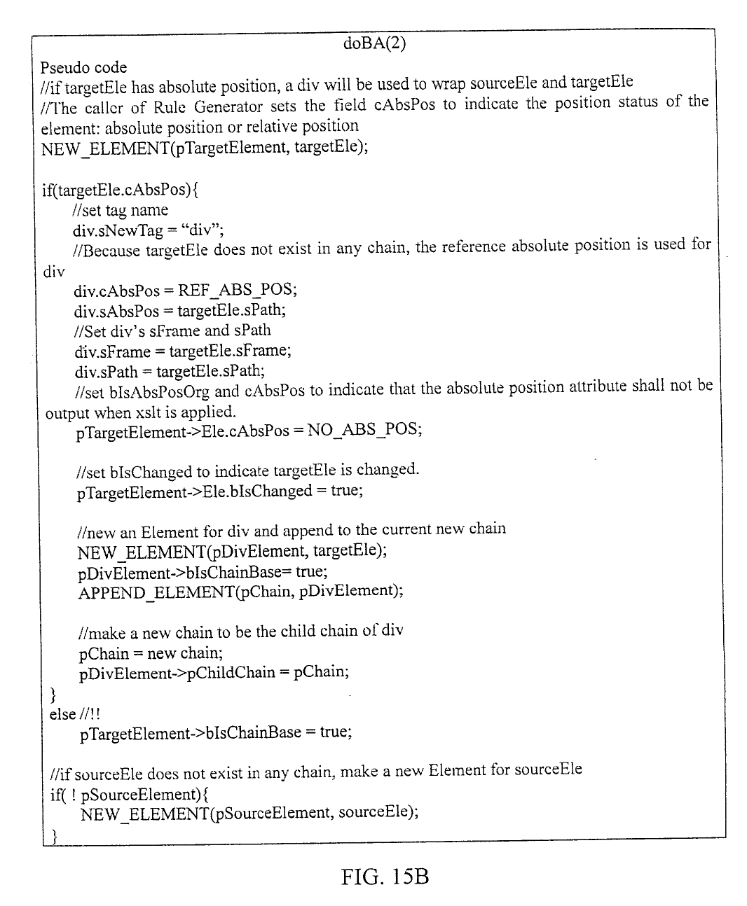

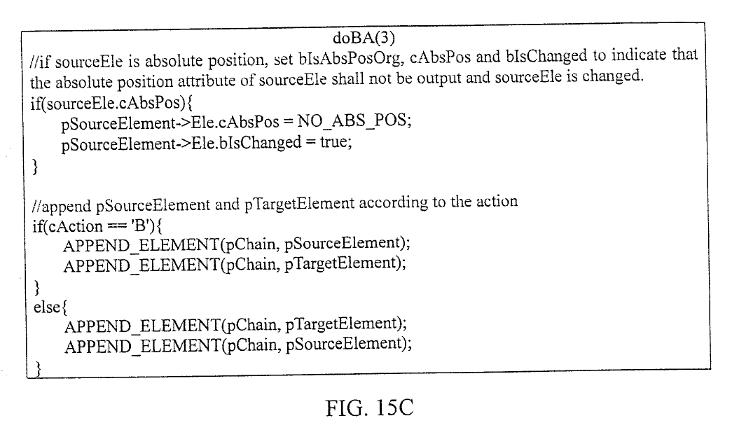

Each of the user choice routines is further detailed below. For the routine doBA (1412), a representative flow chart, and associated pseudocode are shown in FIGS. 15A-15C. As detailed above, the user selection “B” inserts the Source Element before the Target Element, and “A” inserts the Source Element after the Target Element. The routine doBA 1500 first calls the routine NEW_ELEMENT( pTargetElement, targetEle) 1502. If the targetEle has an absolute position, a “div” will be used to wrap sourceEle and targetEle. The caller of the Rule Generator sets the field cAbsPos to indicate the position status of the element: i..e., absolute position or relative position. The targetEle is checked for absolute position in decision block 1504. If yes, then block 1506 sets the div fields (sFrame, sPath, and so forth). The boolean IsChanged is set to indicate that the target Element is changed. The Element(div) is thereafter inserted to the current chain, and the child chain is made to be the current chain. If no, then the pointer to the Source Element is checked for NULL value in block 1508. If NULL, then the Source Element does not exist in any chain, and block 1510 is used to make a new Element. Block 1512 checks if the sourceEle has absolute position. If yes, then the appropriate parameters are set, and sourceEle is changed. If the user action is “B” (1516), then block 1518 will first append pSourceElement to the current chain, then block 1520 will append pTargetElement to the current chain. If user action is not “B”, then block 1522 will first append pTargetElement to the current chain, and then block 1524 will append pSourceElement to the current chain. Control is returned (1526) thereafter.

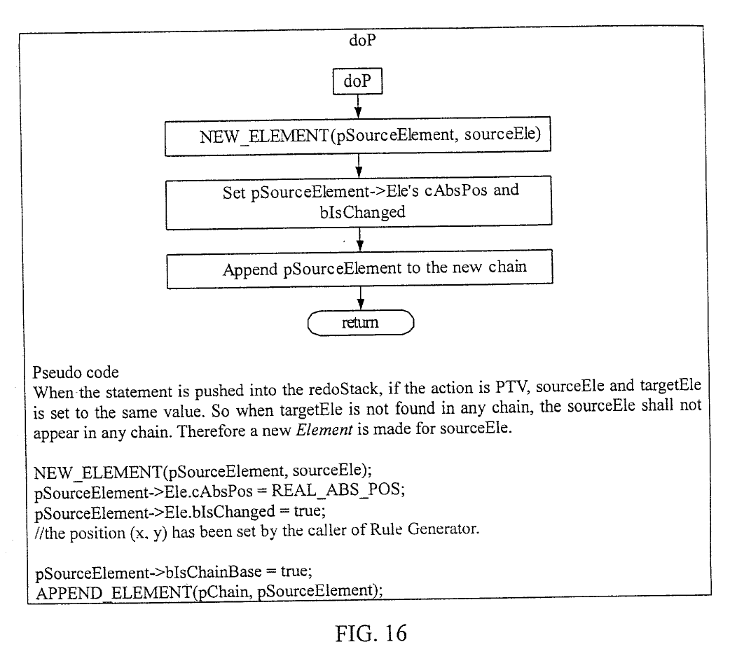

FIG. 16 shows a representative flowchart and pseudocode for the routine doP (1414). The user selection “P” is used to move the Source Element to an absolute position(x, y). For the statement whose corresponding action is “P” “T” or “V”, the sourceEle and targetEle are set to the same value. When targetEle is not found in any chain, the sourceEle shall not appear in any chain. Therefore a new Element is made for sourceEle. Block 1602 shows the call to NEW_ELEMENT( ). Block 1604 shows the absolute position variable and the boolean IsChanged being set. Block 1606 shows the process of appending the pSourceElement to the new chain.

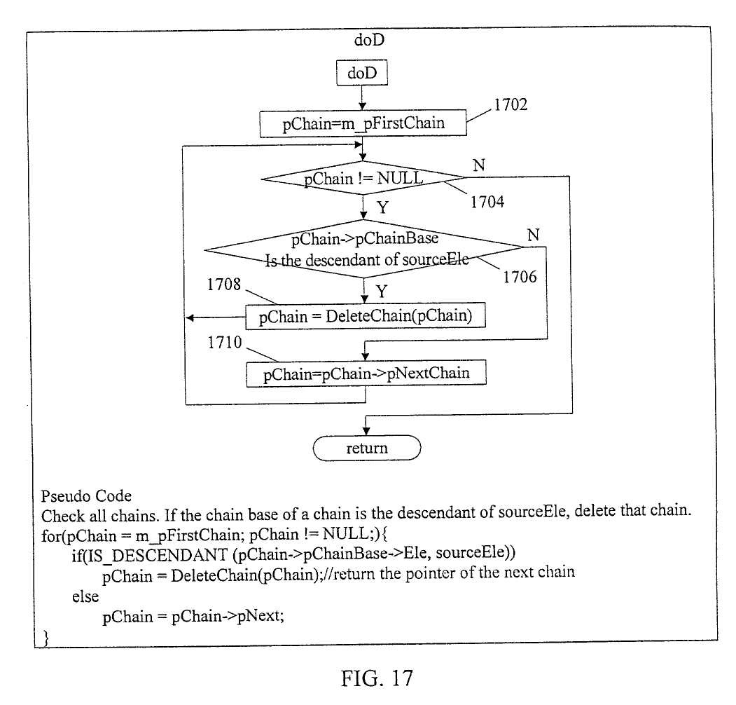

FIG. 17 shows a representative flowchart and pseudocode for the routine doD (1416). The user selection “D” is used to delete the Source Element. A loop is used to check all of the chains. If the chain base of a chain is the descendant of sourceEle, then that chain is deleted. Block 1702 shows initialization of the chain pointer. Block 1704 checks if the pointer is not equal to NULL. If not NULL, then block 1706 checks if the chain base is the descendant of sourceEle. If yes, then block 1708 deletes the chain. If no, then block 1710 sets the chain pointer to the next chain and the process repeats.

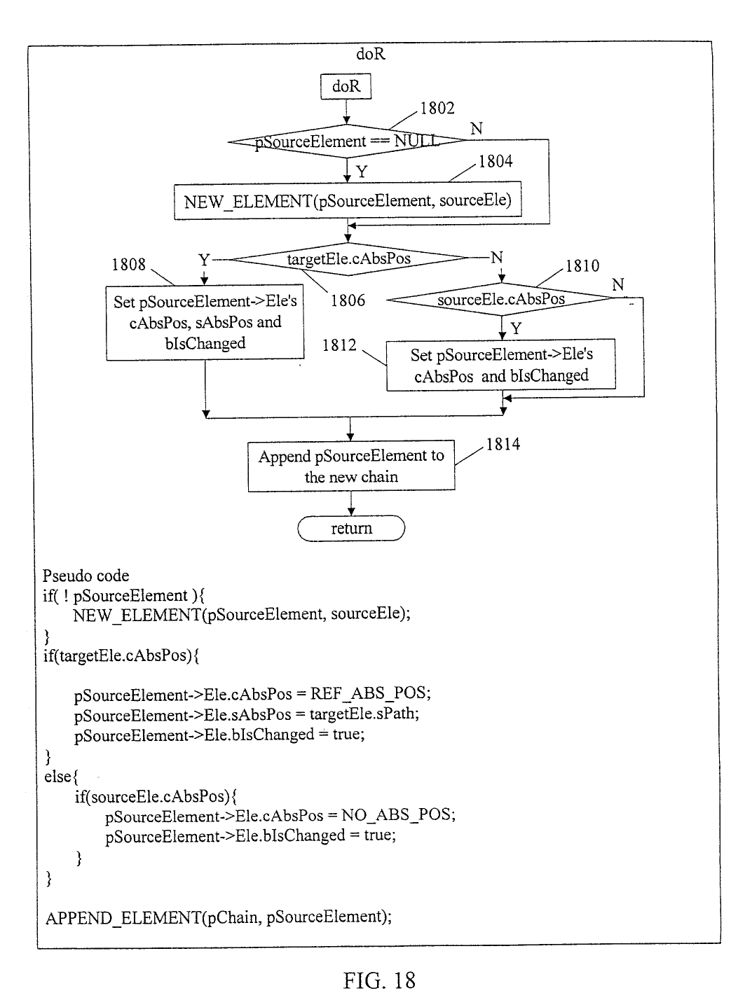

FIG. 18 shows a representative flowchart and pseudocode for the routine doR (1418). The user selection “R” is used to replace the Target Element with a Source Element. Block 1802 first checks if the pSourceElement is NULL. If yes, then the NEW ELEMENT routine 1804 retrieves a new element for the sourceEle. If no, then the targetEle's absolute position indicator is tested in block 1806. If yes, then set the pSourceElement variables accordingly in block 1808. If no, then check the absolute indicator for the source element in block 1810. If yes, then set the pSourceElement variables in block 1812. Thereafter, append the pSourceElement to the new chain in block 1814.

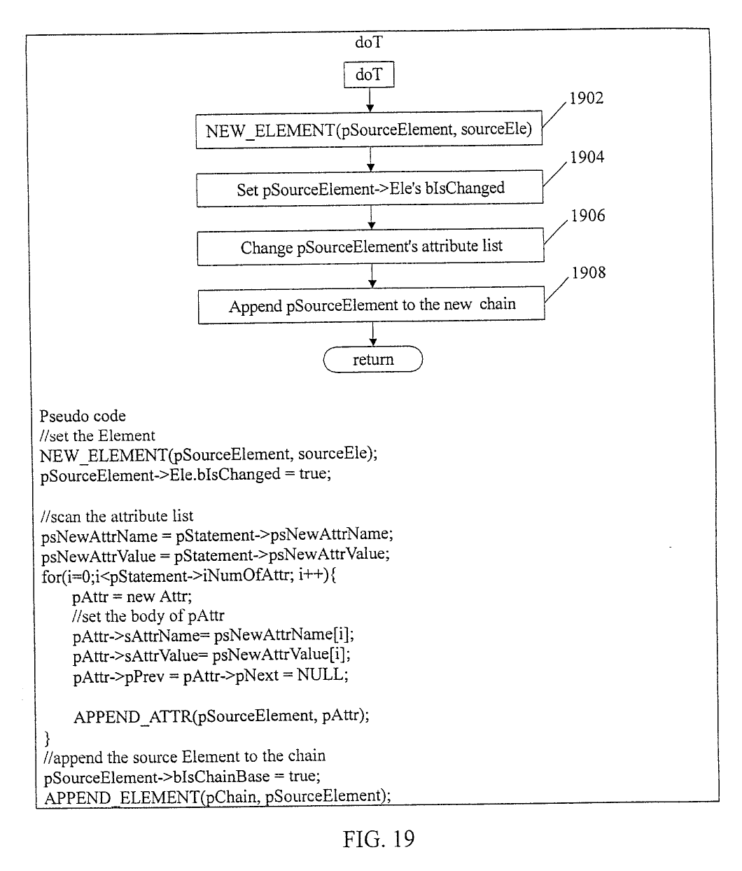

FIG. 19 shows a representative flowchart and pseudocode for the routine doT (1420). The user selection “T” is used to change the attributes of source element. Block 1902 shows a new element being retrieved. Block 1904 shows setting the boolean IsChanged. Block 1906 shows changing the pSourceElement's attribute list, and block 1908 shows appending the pSourceElement to the new chain.

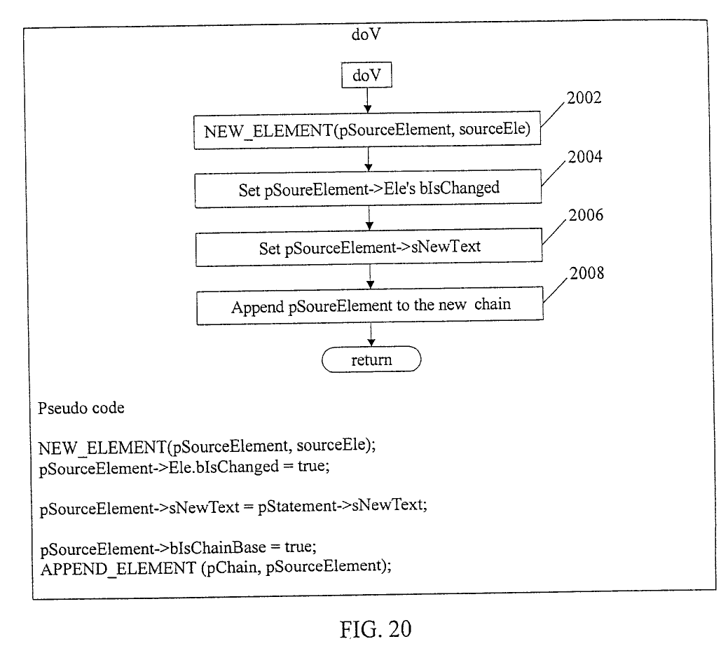

FIG. 20 shows a representative flowchart and pseudocode for the routine doV (1422). The user selection “V” is used to replace the value of the source element with that stored in sNewValue (i.e., actual text). Block 2002 retrieves the new element sourceEle. Block 2004 sets the boolean to indicate that the Element is changed. Block 2006 set the pSourceElement's new text string. Block 2008 appends the pSourceElement to the new chain.

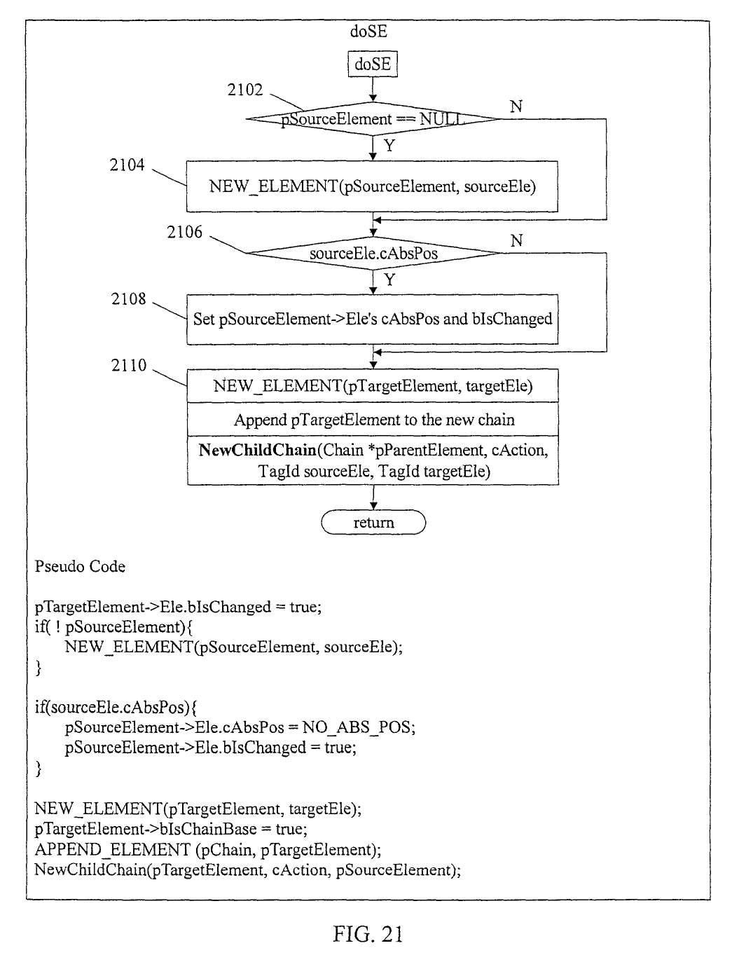

FIG. 21 shows a representative flowchart and pseudocode for the routine doSE (1424). The user selection “S” is used to insert the source element just after the start tag of the target element. The user selection “E” is used to insert the source element just before the end of the target element. Block 2102 checks if the pointer to the source element is NULL. If yes, then block 2104 retrieves a new source element. Block 2016 checks if the source is in absolute position. If yes, the position is set and the boolean indicates a change. Block 2110 retrieves a new target Element, then appends the target Element to the new chain, and then retrieves a new child chain.

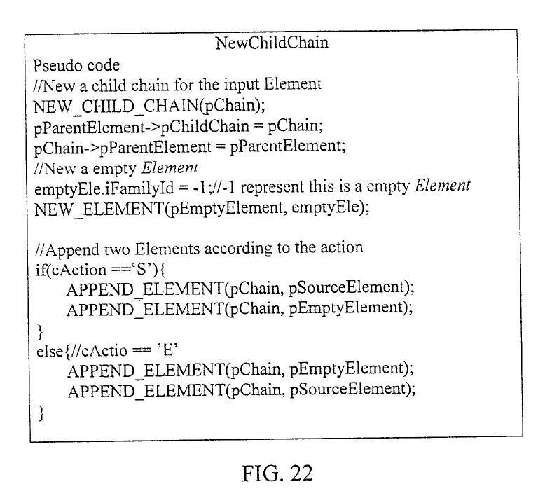

The method “NewChildChain” 1012 serves to make a new chain to be the child of an Element, and set its Elements. Representative pseudocode is shown in FIG. 22. The method first creates a child chain for the input element. Next a new empty Element is created. Thereafter, the empty Element and source Element are appended together according to the action “S” or “E”.

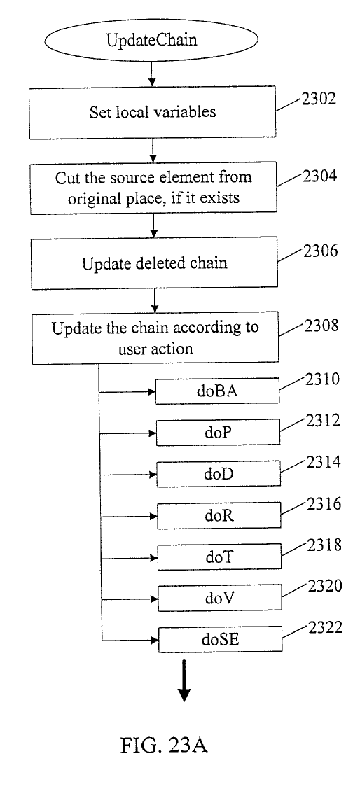

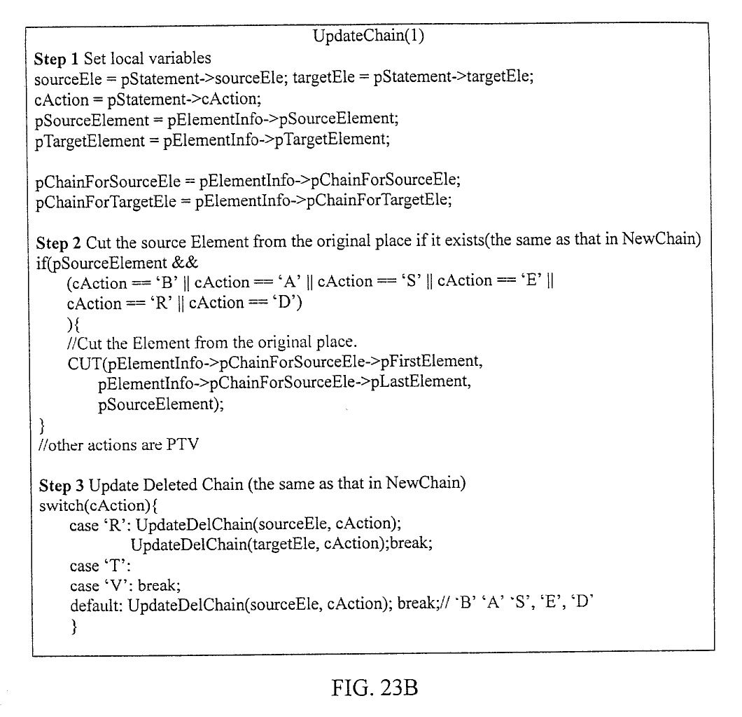

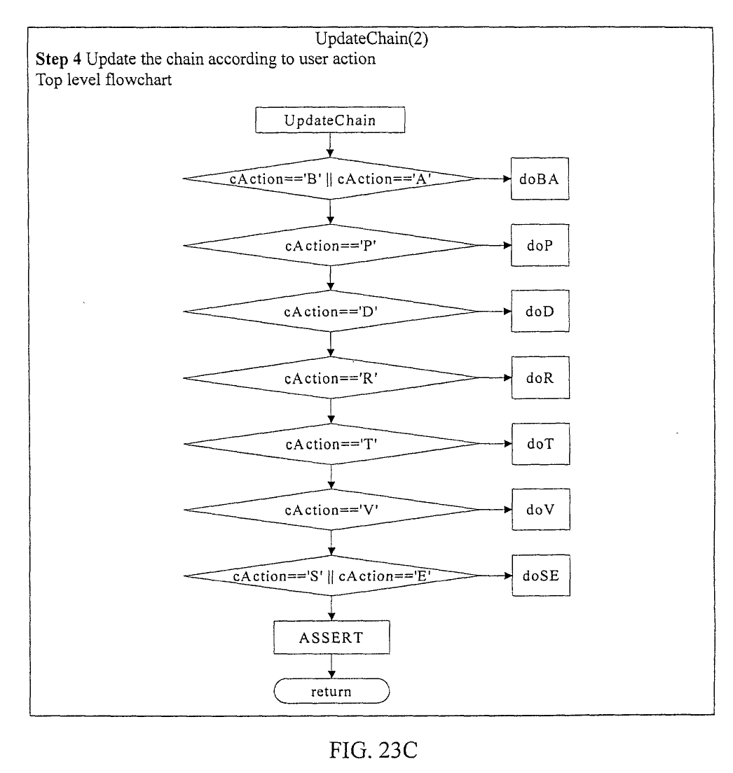

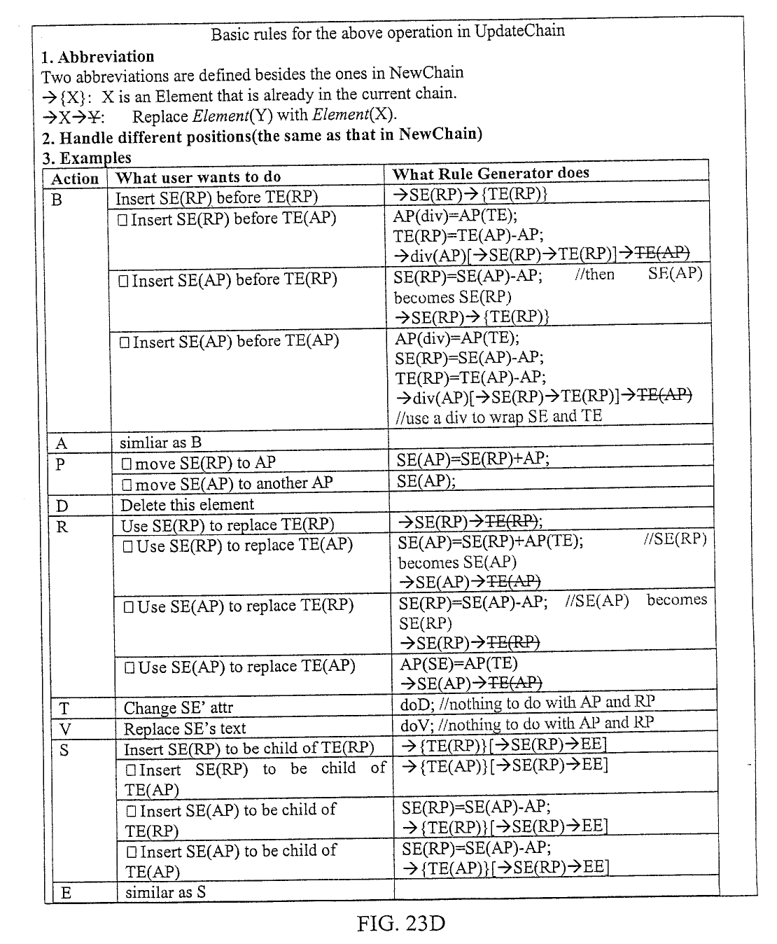

The method “UpdateChain” 1014 updates the chain, wherein updating means adding/deleting/editing Elements in the chain. UpdateChain includes certain steps as illustrated in FIG. 23A, and further described via pseudocode and flowcharts in FIGS. 23B and 23C. The first step 2302 sets local variables. Step 2304 cuts the source Element from the original place, if it exists (same as in NewChain). Step 2306 updates the Deleted Chain (same as in NewChain). Step 2308 updates the chain according to the user action. As before the user actions include doBA, doP, doD, doR, doT, doV, and doSE (shown labeled as 2310-2322 respectively). The flowchart of FIG. 23C again shows the user actions (B, A, P, D, R, T, V, S, and E) for invoking the routines. FIG. 23D provides a summary table of operations related to the private method UpdateChain. Basic rules (in addition to those of FIG. 14D) are provided, along with Examples based upon the Action, What the user wants to do, and What the Rule Generator will do.

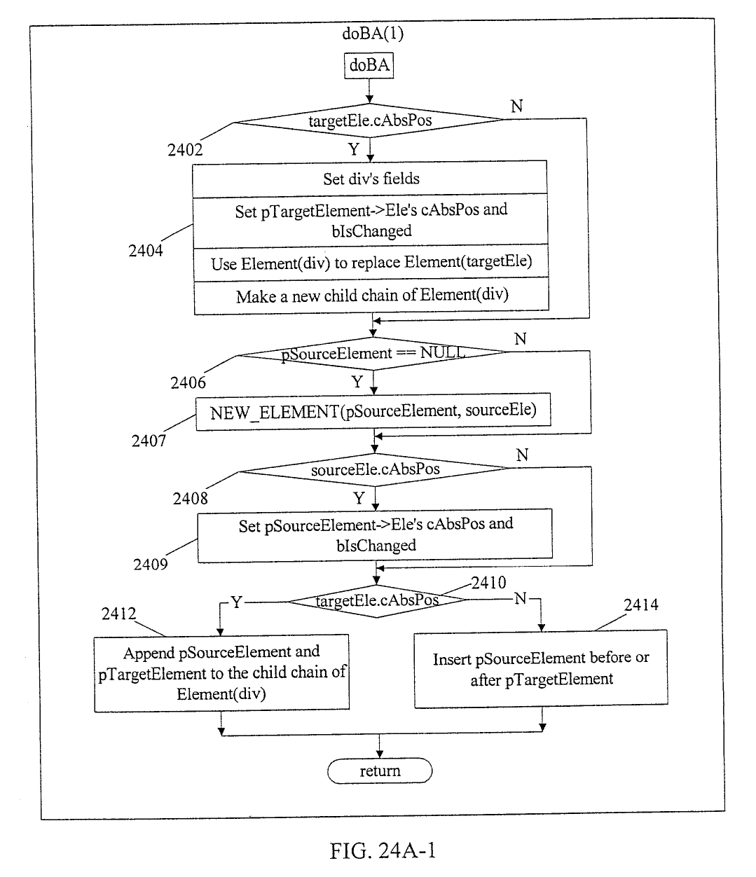

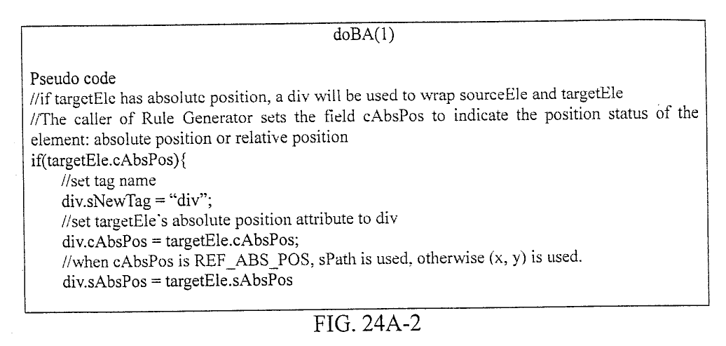

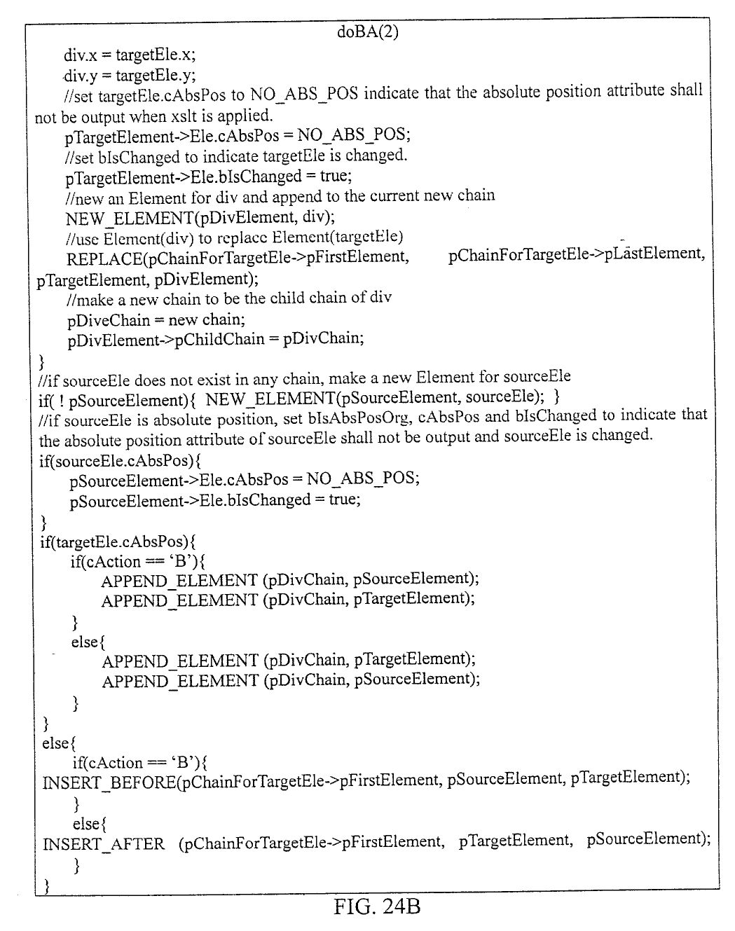

Representative flowcharts and pseudocode for the user action routines are shown in FIGS. 24-30. FIGS. 24A-24B show the flowchart and pseudocode for the routine doBA (2310). As detailed above, the user selection “B” inserts the source element before the target element, and “A” inserts the source element after the target element. Block 2402 checks the Target Element for absolute position. If yes, block 2404 sets the div fields, sets the Target Element variables, replaces the Element(targetEle) with Element(div), and makes a new child chain of the Element(div). Block 2406 next checks if the Source Element is NULL. If yes, then a new source Element is retrieved in block 2407. Block 2408 checks the source element for absolute position. If yes, then the source Element's variables are set in block 2409. Next block 2410 checks the target element (again) for absolute position. If yes, then block 2412 appends the Source Element and Target Element to the child chain of Element(div). If no, then block 2414 inserts the Source Element before or after the Target Element.

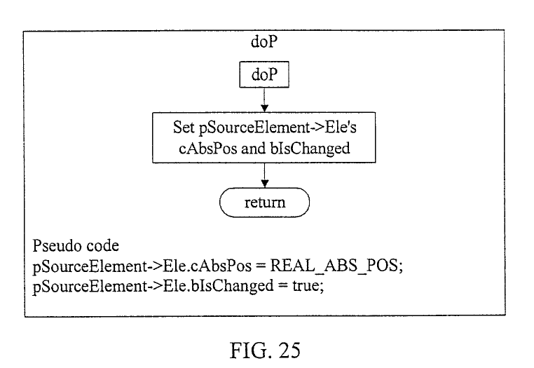

FIG. 25 shows a representative flowchart and pseudocode for the routine doP (2312). The user selection “P” is used to move the source element to an absolute position (x, y). In block 2502, this routine simply sets the Source Element to the real absolute position, and sets the IsChanged boolean to true.

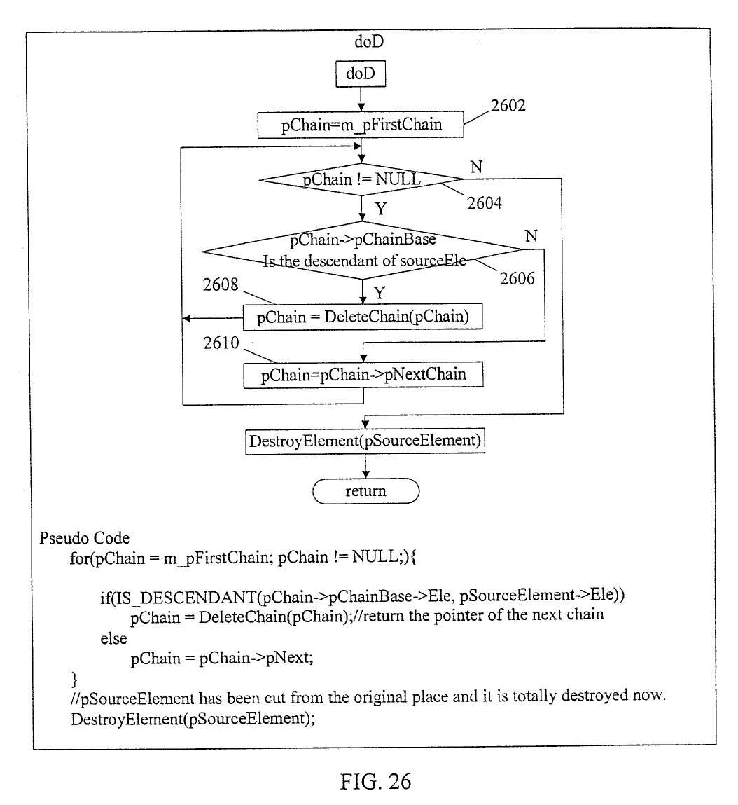

FIG. 26 shows a representative flowchart and pseudocode for the routine doD (2314). The user selection “D” is used to delete the source element. Block 2602 initializes the chain pointer to the first chain. Block 2604 checks if the pointer is NULL. If yes, then block 2606 checks if the chain base is the descendant of sourceEle. If yes, then block 2608 deletes the chain. If no, then the chain pointer is set to the next chain, and the routine loops back. If the chain pointer is NULL from block 2604, then block 2610 is used to destroy the source element.

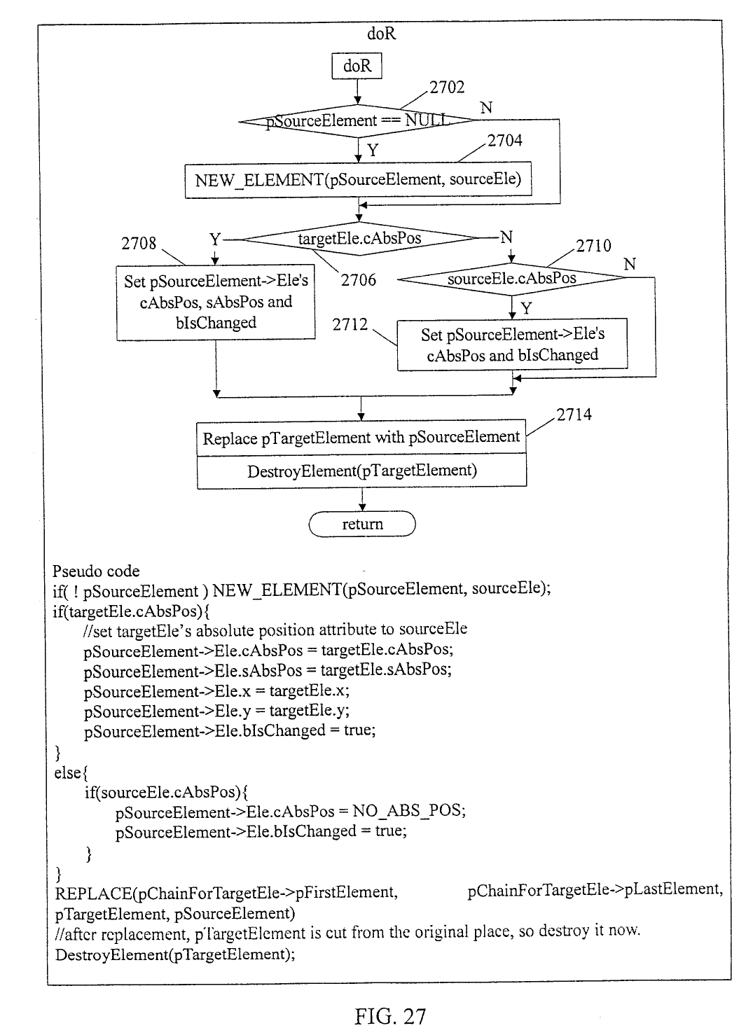

FIG. 27 shows a representative flowchart and pseudocode for the routine doR (2316). The user selection “R” is used to replace the target element with a source element. Block 2702 checks if the source element is NULL. If yes, block 2704 retrieves a new Source Element. Block 2706 checks Target Element for absolute position. If yes, then block 2708 sets the variables cAbsPos, sAbsPos, x, y, and the boolean IsChanged for the source element. If no, then block 2710 checks the source element for absolute position. If yes from block 2710, then block 2712 sets the absolute position and boolean IsChanged for the source Element. Thereafter block 2714 replaces the target Element with the source Element, and then destroys the target Element.

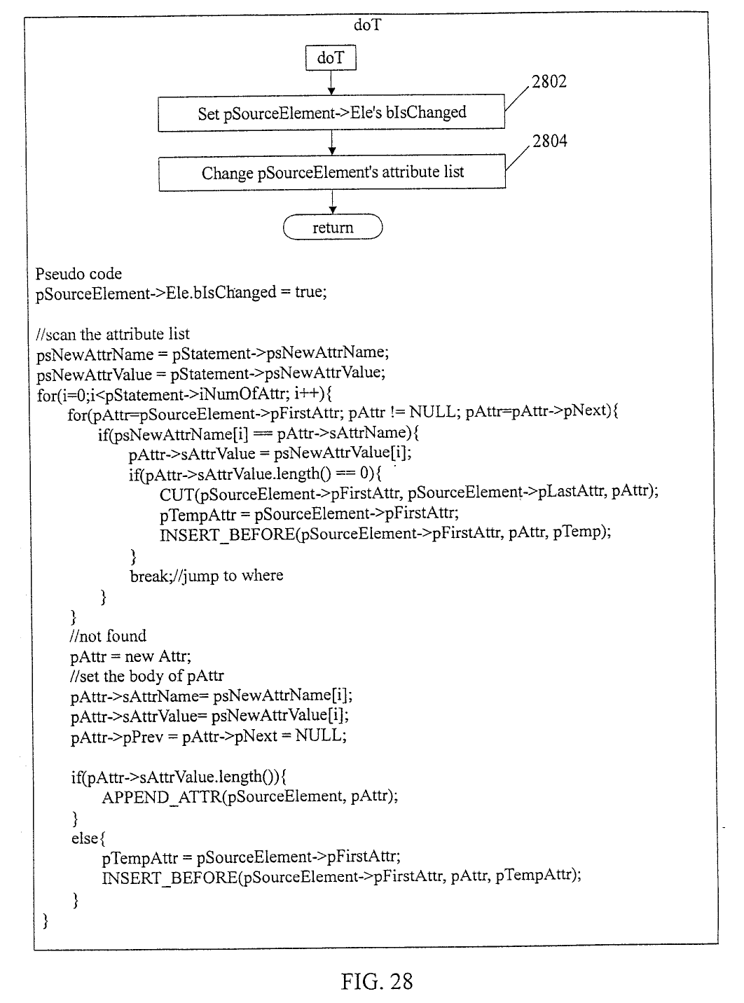

FIG. 28 shows a representative flowchart and pseudocode for the routine doT (2318). The user selection “T” is used to change the attributes of the source element. Block 2802 sets the boolean IsChanged for the source element to true. Block 2804 changes the source elements via scanning the attribute list, and then setting the body of the attribute.

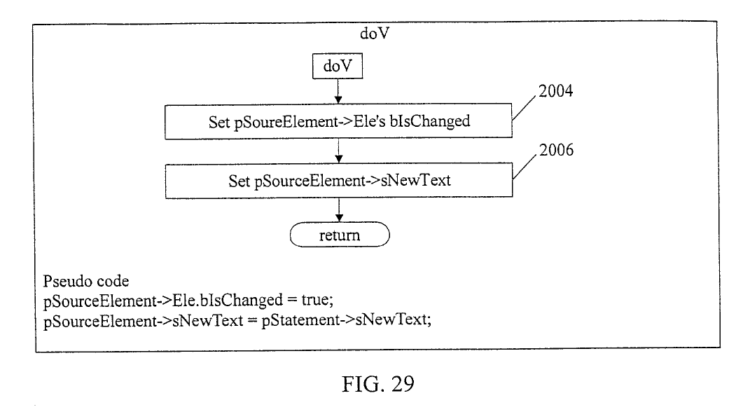

FIG. 29 shows a representative flowchart and pseudocode for the routine doV (2320). The user selection “V” is used to replace the value of the source element with that stored in sNewValue (i.e., actual text). Block 2902 shows the boolean IsChanged for the source element being set to true. Block 2904 shows source Element's new value is set by sNewText.

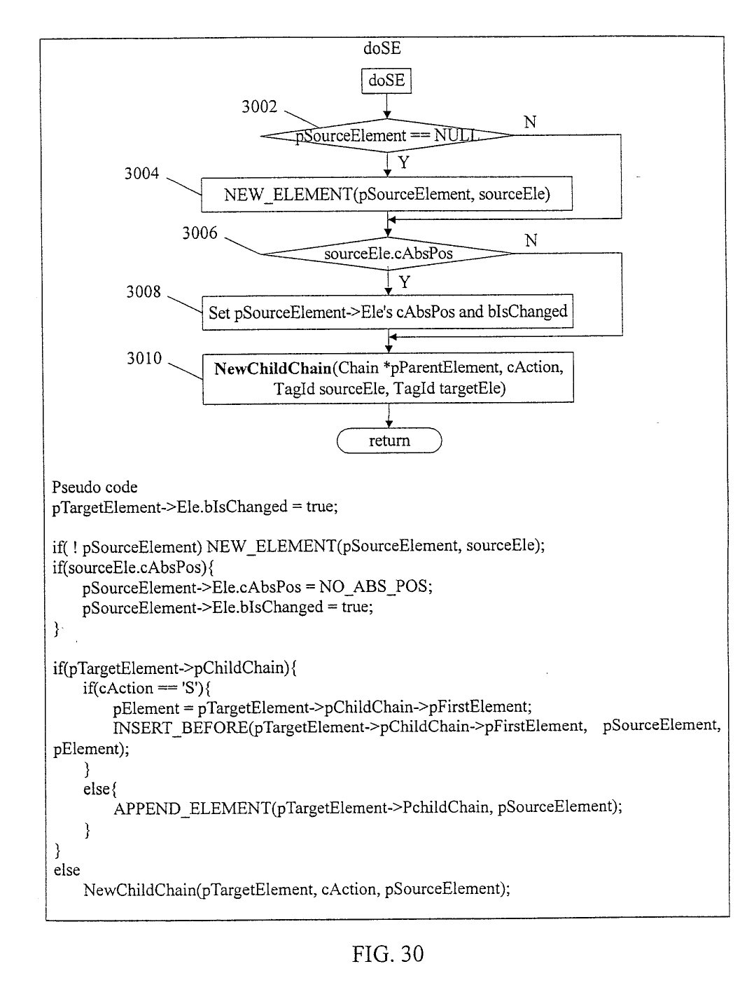

FIG. 30 shows a representative flowchart and pseudocode for the routine doSE (2322). The user selection “S” is used to insert the source element just after the start tag of the target element. The user selection “E” is used to insert the source element just before the end tag of the target element. Block 3004 is used to retrieve a new source Element. Block 3006 checks if the source element is in absolute position. If yes, then block 3008 sets the source Element's absolute position and boolean IsChanged variables. Insertion of the source Element is conditioned upon the user choice. Block 3010 thereafter calls for a new child chain.

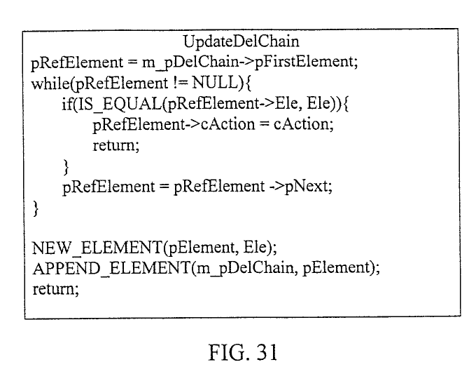

The method “UpdateDelChain” 1016 serves to update the Elements in a Deleted Chain with parameters. If the Element(Ele) is not in the Deleted Chain, then it is appended to the Deleted Chain. Otherwise, the new Element is used to overwrite the existing one. Representative pseudocode is shown in FIG. 31.

The method “FilterDelChain” 1018 serves to filter Elements in the Deleted Chain (i.e., m_pDelChain). Some Elements may be deleted from the Deleted Chain. As a basic rule, if one element is satisfied that can be scanned from its ancestor, and it is moved, then this Element(element) is qualified for staying in the Deleted Chain. In order to determine if one element can be scanned from the ancestor, the following can be applied because the template file will be totally scanned, each element in the template will be scanned from its ancestor. As a result, if one element in the template file is moved from its original position, then it must be put into the Deleted Chain. For the source file, every POS_MOV action shall insert Element(sourceEle) into the Deleted Chain. After all the statements have been analyzed, each Element in the Deleted Chain shall be checked as to whether it will be deleted from Deleted Chain.

A representative algorithm might be described as follows:

For an Element in Deleted Chain,

If there is no ancestor in the Deleted Chain,

OR

The last action of its youngest ancestor in the Deleted Chain is “D”,

Then it will be filtered out.

Otherwise it shall be kept in the Deleted Chain.

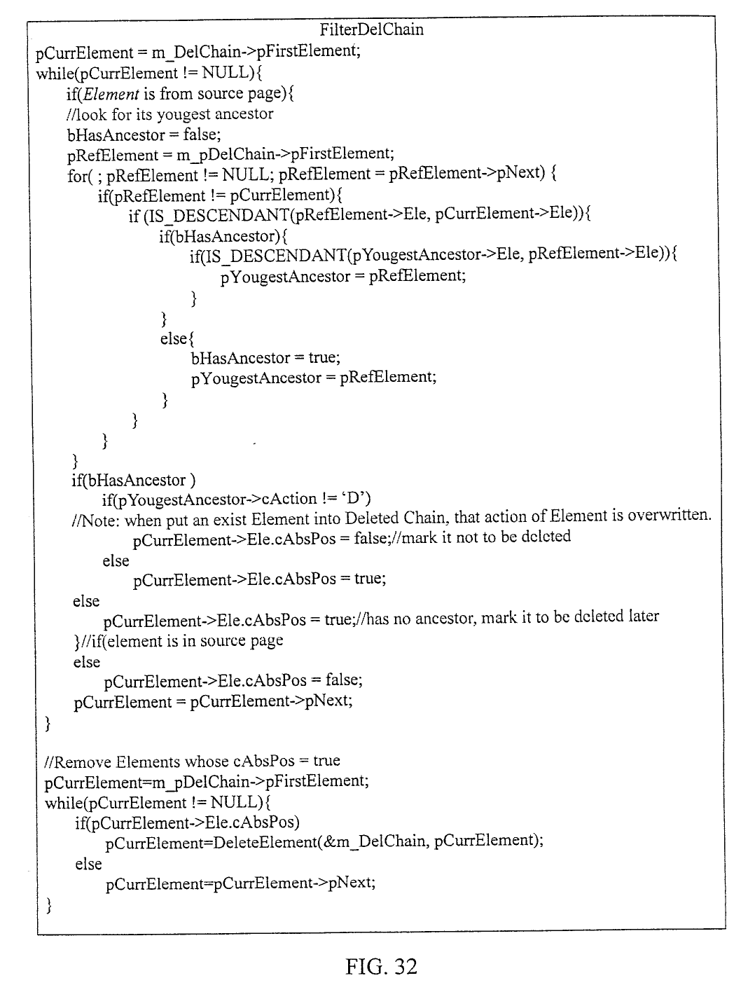

Representative pseudocode is shown in FIG. 32.

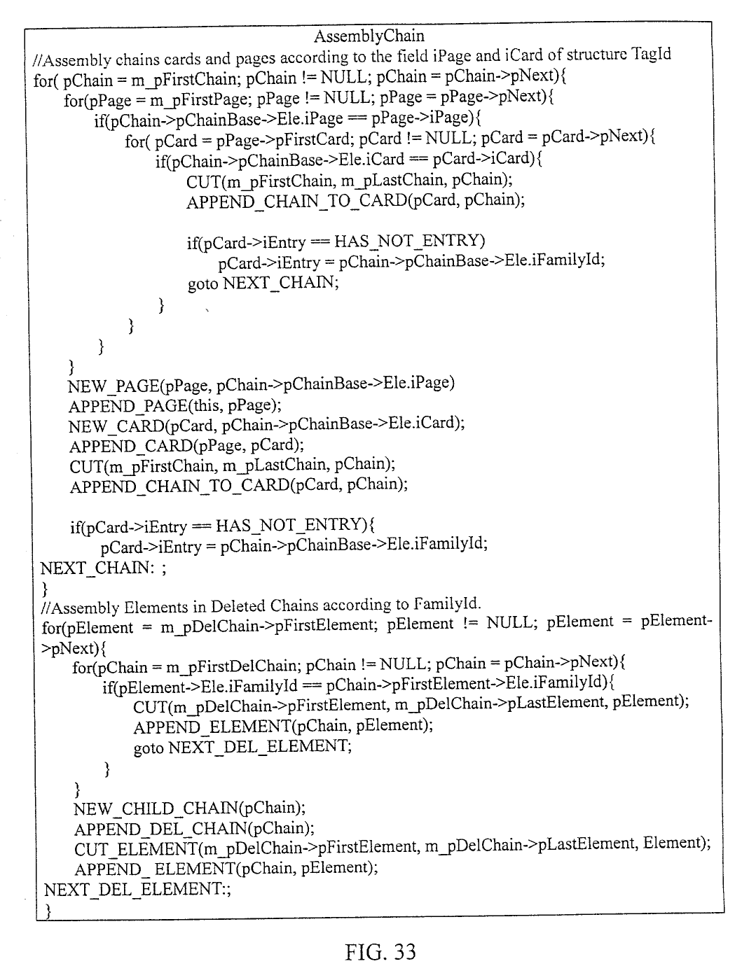

The method “AssemblyChain” 1018 serves to assemble the chains pointed to by m_pFirstChain to cards and pages according to the field iPage and iCard of the structure TagId. The method also serves to assemble the Elements in m_pDelChain to several new chains pointed by m_pFirstDelChain according to the iFamilyId of Elements. Representative pseudocode is shown in FIG. 33.

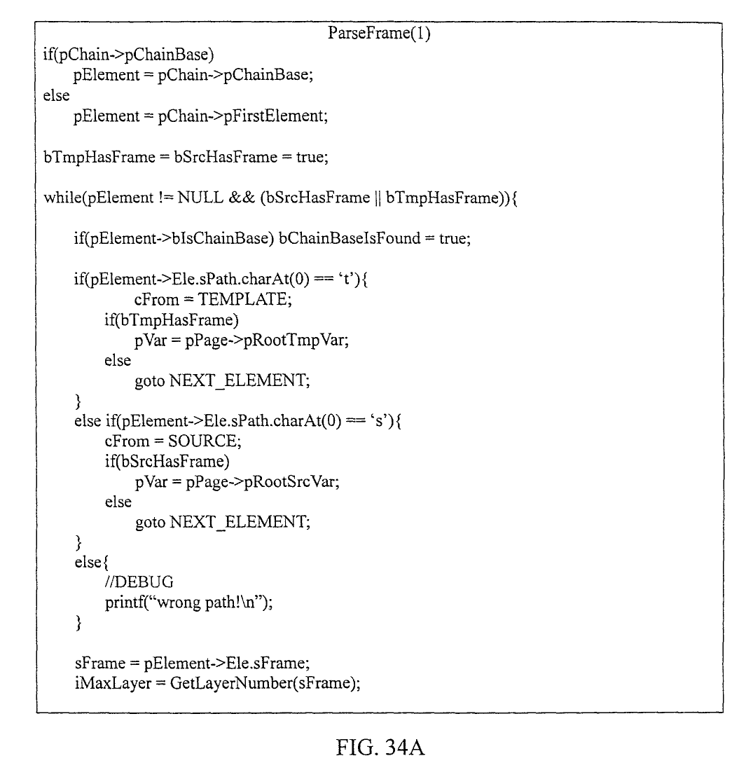

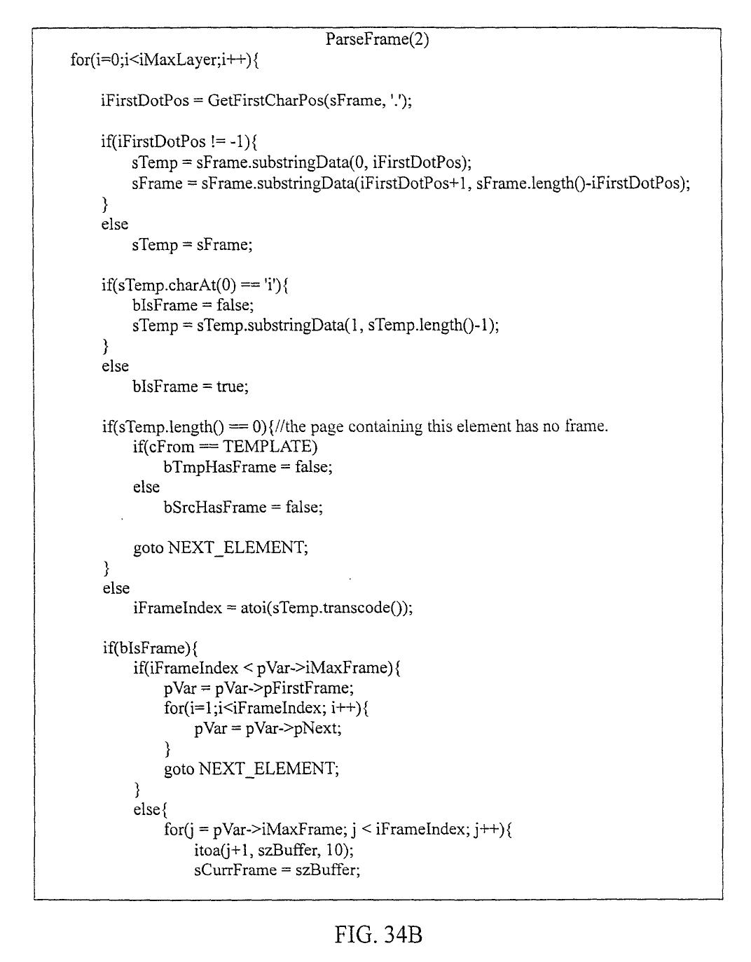

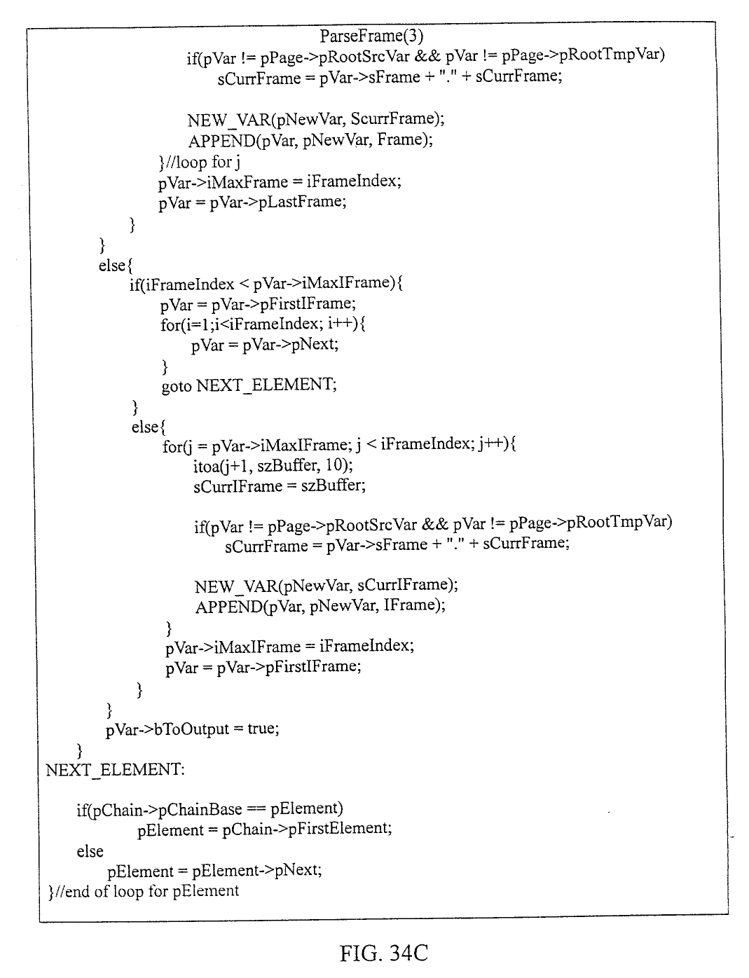

The method “ParseFrame” 1020 serves to parse the “sFrame” field of the structure “Element” for each element (including the chain base) in the chain. Each page has two Var trees for the template file and the source file respectively. Representative pseudocode is shown in FIGS. 34A-34C.

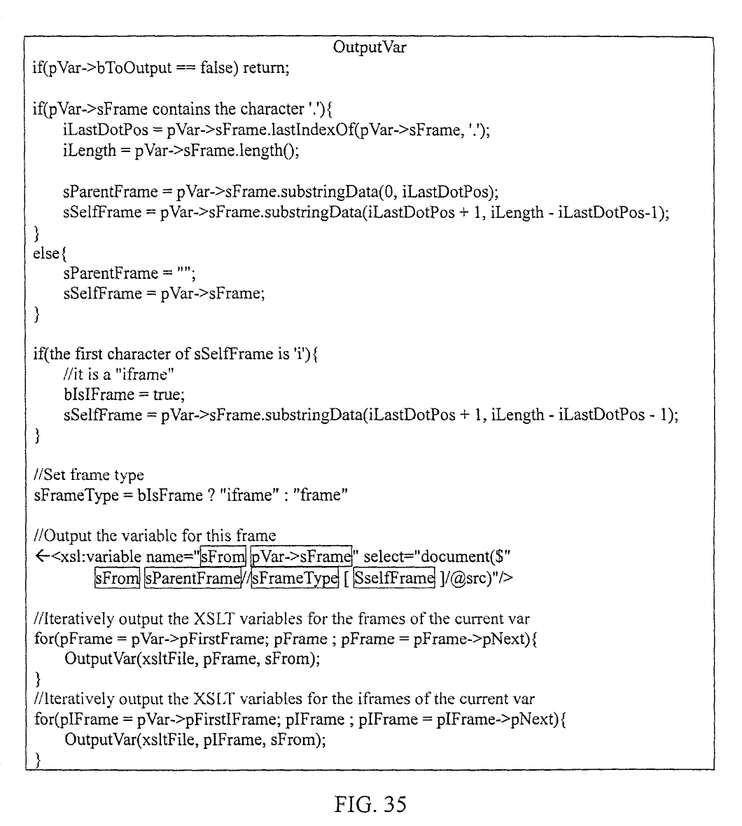

The method “OutputVar” 1022 serves to generate XSLT variables for the frames. The frame type is set, and then the variable is output for this frame. The method then iteratively outputs the XSLT variables for the frames of the current Var. Thereafter the method interatively outputs the XSLT variables for the iframes of the current Var. Representative pseudocode is shown in FIG. 35.

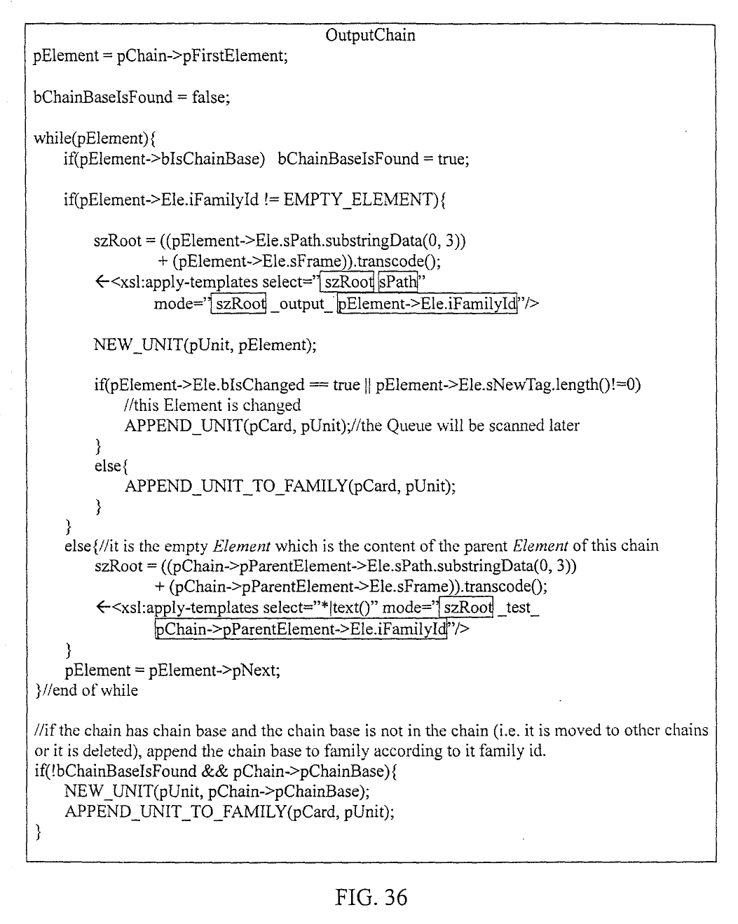

The method “OutputChain” 1024 serves to generate XSLT for the Elements in the chain. The Element pointer is set to the first in the chain. For each non-empty Element in the chain, the XSLT is sequentially generated. If the Element is changed, a new unit is retrieved, then the Unit is appended, with the Queue being scanned later. If the Element is not changed, then the Unit is appended to the Family. If the Element is empty, then it is the content of the parent Element of the chain. Thereafter, if the chain has a chain base and the chain base is not in the chain (i.e., it is moved to other chains or it is deleted), then the chain base is appended to the family according to its family id. Representative pseudocode is shown in FIG. 36.

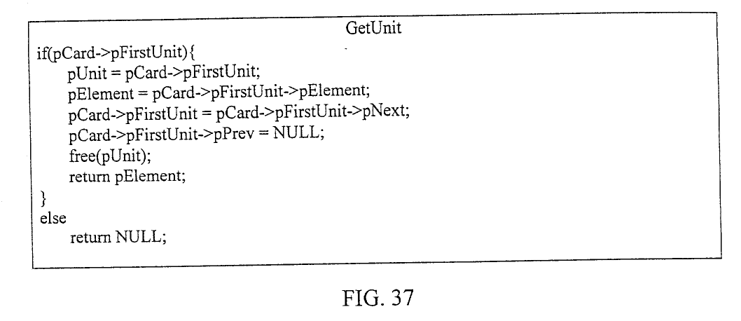

The method “GetUnit” serves to get the pointer (pElement) in the first unit in the queue, and delete (or destroy) the first unit from the queue. When all units in the queue are picked out, the XSLT for all the Elements in the Sequence Chains in the card are output. Representative pseudocode is shown in FIG. 37.

APPENDIX A
2.4. Macros
The following macros are in macro.h
2.4.1. Constant Value
#define SOURCE 0
#define TEMPLATE 1
#define NO_ABS_POS 0
#define REF_ABS_POS 1
#define REAL_ABS_POS 2
#define FROM_NOWHERE 0
#define FROM_M_PFIRSTCHAIN 1
#define FROM_CARD 2
#define FROM_M_PFIRSTDELCHAIN 3
2.4.2. INIT
2.4.2.1. INIT_STACK
#define INT_STACK(stack)\

stack.pFirstStatement = NULL;\
stack.pLastStatement = NULL;

2.4.2.2. INIT_CHAIN
#define INIT_CHAIN(Chain)\

Chain.bIsApplied = false;

2.4.3. FREE
#define FREE(pFirst, p)\

while(pFirst){\

p = pFirst->pNext;\
free(pFirst);\
pFirst = p;\

}\
p = pFirst;

2.4.3.1. FREE_STACK
#define FREE_STACK(stack)\

FREE(stack.pFirstStatement, pStatement)

2.4.4. NEW
2.4.4.1. NEW_PAGE
#define NEW_PAGE(pPage, iChainBasePage)\

pPage = new Page;\
pPage->iPage = iChainBasePage;\
pPage->pFirstCard = NULL;\
pPage->pLastCard = NULL;\
pPage->pRootTmpVar= NULL;\
pPage->pRootSrcVar= NULL;\
pPage->pPrev NULL;\
pPage->pNext NULL;

2.4.4.2. NEW_CARD
#define NEW_CARD(pCard, iChainBaseCard)\

pCard = new Card;\
pCard->iCard = iChainBaseCard;\
pCard->iEntry = −1;\
pCard->pFirstChain = NULL;\
pCard->pLastChain= NULL;\
pCard->pFirstUnit = NULL;\
pCard->pLastUnit = NULL;\
pCard->pPrev = NULL;\
pCard->pNext = NULL;

2.4.4.3. NEW_ELEMENT
#define NEW_ELEMENT(pElement, Ele)\
pElement = new Element;
pElement->pPrev = NULL;
pElement->pNext = NULL;
pElement->pFirstAttr = NULL;
pElement->pLastAttr = NULL;
pElement->pChildChain = NULL;
pElement->bIsChainBase = false;
pElement->Ele = Ele;
pElement->Ele.bIsAbsPosOrg = Ele.cAbsPos;
pElement->Ele.bIsChanged = FASLE;
2.4.4.4. NEW_CHAIN
#define NEW_CHAIN(pChain, targetEle)\
pChain = new Chain;\
pChain->bIsApplied false;\
NEW_ELEMENT(pChain->pChainBase, targetEle);\
pChain->pFirstElement = NULL;\
pChain->pLastElement = NULL;\
pChain->pPrev = NULL;\
pChain->pNext = NULL;
Macro NEW_CHAIN is used in private method NewChain, NewChildChain, NewDivChildChain.
2.4.4.5. NEW_CHILD_CHAIN
#define NEW_CHILD_CHAIN(pChain)\
pChain = new Chain;\
pChain->bIsApplied = false;\
pChain->pChainBase = NULL;\
pChain->pFirstElement = NULL;\
pChain->pLastElement = NULL;
pChain->pPrev = NULL;\
pChain->pNext = NULL;
2.4.4.6. NEW_UNIT
#define NEW_UNIT(pUnit, pElement)\
pUnit = new Unit;\
pUnit->pElement = pElement;\
pUnit->pPrev = NULL;\
pUnit->pNext = NULL;\
2.4.4.7. NEW_FAMILY
#define NEW_FAMILY(pFamily, pUnit)\
pFamily = new Family;\
pEamily->iFamilyId = pUnit->pElement->Ele.iFamilyId;\
pFamily->pFirstUnit = pFamily->pLastUnit = pUnit;\
pFamily->pPrev = pFamily->pNext = NULL;
2.4.4.8. NEW_VAR
#define NEW_VAR(pVar, sCurrFrame)\

pVar = new Var;\
pVar->iMaxFrame = 0;\
pVar->iMaxIFrame =0;\
pVar->sFrame = sCurrFrame;\
pVar->bToOutput false;\
pVar->pPrev = NULL;\
pVar->pNext = NULL;\
pVar->pFirstFrame = NULL;\
pVar->pLastFrame = NULL;\
pVar->pFirstIFrame= NULL;\
pVar->pLastIFrame= NULL;
2.4.5. APPEND
#define APPEND(pList, member, pItem, ItemName)
if(pList->member##pLast##ItemName)
pList>member##pLast##ItemName->pNext = pItem;

else

pList->member##pFirst##ItemName=pItem;

pItem->pPrev = pList->member##pLast##ItemName;
pItem->pNext = NULL;
pList->member##pLast##ItemName = pItem;
#define APPEND_M(pList, member, pItem, ItemName)\
if(pList->member##pLast##ItemName)\

pList->member##pLast##ItemName->pNext = pItem;\

else\

pList->member##pFirst##ItemName=pItem;\

pltem->pPrev = pList->member##pLast##ItemName;\
pItem->pNext = NULL;\
pList->member##pLast##ItemName = pItem;
2.4.5.1. APPEND_PAGE
#define APPEND_PAGE(this, pPage)\
APPEND_M(this, m_, pPage, Page)
2.4.5.2. APPEND_CARD
#define APPEND_CARD(pPage, pCard)\
APPEND(pPage, pCard, Card)
2.4.5.3. APPEND_ELEMENT
#define APPEND_ELEMENT(pChain, pElement)\
APPEND(pChain, pElement, Element)
2.4.5.4. APPEND_CHAIN
#define APPEND_CHAIN(pChain)\
APPEND_M(this, m_, pChain, Chain)
2.4.5.5. APPEND_CHAIN_TO_CARD
#define APPEND_CHAIN_TO_CARD(pCard, pChain)\
APPEND(pCard, pChain, Chain)
2.4.5.6. APPEND_DEL₁₃ CHAIN
#define APPEND_DEL_CHALN(pChain)\
APPEND_M(this, m_, pChain, DelChain)
2.4.5.7. APPEND_ATTR
#define APPEND_ATTR(pElement, pAttr)\
APPEND(pElement, pAttr, Attr)
2.4.5.8. APPEND_UNIT
#define APPEND_UNIT(pCard, pUnit)
APPEND(pCard, pUnit, Unit);
2.4.5.9. APPEND_FAMILY
#define APPEND_FAMILY(pCard, pFamily)\
APPEND(pCard, pFamily, Family)
2.4.5.10. APPEND_UNIT_TO_FAMILY
#define APPEND_UNIT_TO_FAMILY(pCard, pUnit)\
bFamilyIsFound = false;\
for(pFamily = pCard->pFirstFamily; pFamily; pFamily = pFamily->pNext){\

if(pFamily->iFamilyId == pUnit->pElement->Ele.iFamilyld){\

APPEND(pFamily, pUnit, Unit);\
bFamilyIsFound = true;\
break;\

}\

}\
if(bFamilyIsFound == false){\

NEW_FAMLLY(pFamily, pUnit);\
APPEND_FAMILY(pCard, pFamily);\
APPEND(pFamily, pUnit, Unit);\

}
2.4.6. STATEMENT
2.4.6.1. PUSH_STATEMENT
#define PUSH_STATEMENT(Stack, pStatement)\
if(Stack.pLastStatement)\

Stack.pLastStatement->pNext = pStatement;\

else\

Stack.pFirstStatement=pStatement;\

pStatement->pPrev = Stack.pLastStatement;\
pStatement->pNext = NULL;\
while(pStatement->pNext ?= NULL)\

pStatement=Statement->pNext;\

Stack.pLastStatement = pStatement;
2.4.6.2. POP_STATEMENT
#define POP_STATEMENT(Stack, pStatement)\
pStatement = Stack.pLastStatement\
while(pStatement->bNewAction == false)\

pStatement = pStatement->pPrev;\

Stack.pLastStatement = Stack.pLastStatement->pPrev;\
if(Stack.pLastStatement)\

Stack.pLastStatement->pNext = NULL;\

else\

Stack.pFirstStatement = NULL;

2.4.7. IS
2.4.7.1. IS_DESCENDANT
Decide whether Element Ele_2 is the descendant of Element Ele_1.
#define IS_DESCENDANT(Ele 1, Ele2)\

(Ele_1.iFamilyId == Ele_2.iFamilyId &&\

Ele_1.sPath.substring(Ele_2.sPath)

2.4.7.2. IS_EQUAL
Decide whether Element Ele_2 equals Element Ele_1.
#define IS_EQUAL(Ele_1, Ele_2)\

(Ele_1.iFamilyId == Ele_2.iFamilyId &&\
Ele_1.sPath.equals(Ele_2.sPath))

2.4.8. INSERT
p1 and p2 are two pointers.
2.4.8.1. INSERT_BEFORE
Insert the structure instance pointed by p1 before the one pointed by p2.
#define INSERT_BEFORE(pFirst, p1, p2)
if(p2 == pFirst)\

pFirst = pl;\

else\

p2->pPrev->pNext= pl;\

\
p1->pPrev = p2->pPrev;\
p1->pNext=p2;\
p2->pPrev=p1;
2.4.8.2. INSERT_AFTER
Insert structure instance pointed by p2 after the one pointed by p1
#define INSERT_AFTER(pLast, p1, p2)
if(p1 == pLast)\

pLast = p2;\

else\

p1->pNext->pPrev= p2;\

p2->pNext = p1->pNext;\
p2->pPrev=p1;\
p1->pNext=p2;\
2.4.9. CUT
#define CUT(pFirst, pLast, pCurrent)\
if(pCurrent == pFirst){\

pFirst = pCurrent->pNext;\

}\
else{\

if(pCurrent == pLast){\

pLast = pCurrent->pPrev;\
pLast->pNext = NULL;\

}\
else{\

pCurrent->pPrev->pNext = pCurrent->pNext;\
pCurrent->pNext->pPrev = pCurrent->pPrev;\

}\

}\
pCurrent->pPrev = pCurrent->pNext = NULL;
2.4.9.1. CUT_ELEMENT
#define CUT_ELEMENT(pFirst, pLast, pCurrent)\

CUT(pFirst, pLast, pCurrent)\
pCurrent->bIsChainBase = false;

2.4.10. REPLACE
#define REPLACE(pFirst, pLast, pOld, pNew)\
if(pOld pLast){\

pLast = pNew;\

}\
if(pOld == pFirst) {\

pFirst = pNew;\

}\
if(pOld->pPrev)\

pOld->pPrev->pNext = pNew;\

if(pOld->pNext)\

pOld->pNext->pPrev = pNew;\

pNew->pNext = pOld->pNext;\
pNew->pPrev = pOld->pPrev;\
pOld->pPrev = pOld->pNext = NULL;

APPENDIX B
2.5. Class Definition
class RuleGenerator{
private:

Stack m_redoStack;
Stack m_undoStack;
Page *m_pFirstPage;
Page *m_pLastPage;
Chain *m_pDelChhain
Chain *m_pFirstChain
Chain *m_pLastChain;
Chain *m_pFirstDelChain;
Chain *m_pLastDelChain;
boolm_bCanUndo; m_bCanRedo;

public:

PageRulem_FirstRule;

private:

void DestroyElement(Element *pElement);
Element *DeleteElement(Chain *pChain, Element *pElement);
void LocateElement(Chain *pChain, ElementInfo *pElementInfo);
void NewChain(ElementInfo *pElementInfo, Statement *pStatement);
Chain *DeleteChain(Chain *pChain, Card *pCard=NULL, int

mode=FROM_NOWHERE);

void NewChildChain(Element *pParentElement, char cAction, Element

*pSourceElement);

void UpdateChain(ElementInfo *pElementInfo, Statement *pStatement);
void UpdateDelChain(TagId Ele, char cAction);
void FilterDelChain();
void AssemblyChain();
void ParseFrame(Chain *pChain, Page *pPage);
void OutputVar(ostream& xsItFile, Var *pVar, DOMString sFrom);
void OutputChain(ostream& xsltFile, Card *pCard, Chain *pChain);
Element *GetUnit(Card *pCard);

public:

Statement(); //initialize the redo & undo stack(alloc memory for them)
˜Statement(); //free the space

public:

void PushStatement(char cAction, TagId sourceEle, TagId targetEle, bool bNewAction);
void PushStatement(char cAction, TagId sourceEle, bool bNewAction);
void PushStatement(TagId sourceEle, DOMString psNewAttrName[], DOMString

psNewAttrValue[], int iNumOfAttr, bool bNewAction);

void PushStatement(TagId sourceEle, DOMString sNewText, bool bNewAction)
void UndoStatement();
void RedoStatement();
bool CanRedo();
bool CanUudo();
void GenerateXSLT();
char *SaveTempXSLT(int iPage, int iFrame)

};

1. A method for generating a set of transform rules to be used in transforming web-based information from a source page format to a web-enabled receiving device template page format, the transformation occurring in response to a request for the web-based information by the receiving device, the method comprising:
displaying the source page and the template page using a graphical user interface;
identifying elements within the information displayed on the source page and the template page;
recording user actions for arranging the elements on the source page and the template page, the user actions being recorded onto at least two stacks, with certain stacks being associated with certain user actions;
using the at least two stacks as the basis for supporting the user actions;
generating chains of elements from the at least two stacks;
providing XSLT from the generated chains; and
generating the set of transform rules for the source page according to the source page URL, the XSLT, and the receiving device.

2. The method of claim 1, wherein the at least two stacks include a redostack and an undostack.

3. The method of claim 2, wherein the supported user actions include undo and redo actions.

4. The method of claim 1, wherein the chains include at least two kinds including Deleted Chain and Sequence Chain.

5. The method of claim 1, wherein the steps include: providing a user interface that includes two frames displayed in a browser.

6. The method of claim 5, wherein the two frames include a left frame, and the steps include loading the template page onto the left frame.

7. The method of claim 5, wherein the two frames include a right frame, and the steps include loading the source page into the right frame.

8. The method of claim 5, wherein the steps include adding identifier and path information as the attributes of each element in the two pages.

9. The method of claim 5, wherein the user interface further includes the step of providing at least four buttons in the user interface including Undo, Redo, ViewXSLT, and Finish.

10. The method of claim 9, wherein when the user clicks Undo, the steps include canceling the latest action.

11. The method of claim 9, wherein when the user clicks Redo, the steps include restoring the latest Undo action.

12. The method of claim 9, wherein when the user clicks ViewXSLT, the steps include the client session requesting the server session to generate XSLT according to the user actions.

13. The method of claim 9, wherein when the user clicks Finish, the steps include the client session requesting the server session to generate XSLT and RDF for this page.

14. The method of claim 1, wherein one user action includes a keystroke for inserting the source element before the target element.

15. The method of claim 1, wherein one user action includes a keystroke for inserting the source element after the target element.

16. The method of claim 1, wherein one user action includes a keystroke for moving the source element to an absolute x, y position.

17. The method of claim 1, wherein one user action includes a keystroke for deleting the source element.

18. The method of claim 1, wherein one user action includes a keystroke for replacing the target element with the source element.

19. The method of claim 1, wherein one user action includes a keystroke for changing the attributes of the source element.

20. The method of claim 1, wherein one user action include a keystroke for replacing the value of the source element with a new value.

21. The method of claim 1, wherein one user action includes a keystroke for inserting the source element just after the start tag of the target element.

22. The method of claim 1, wherein one user action includes a keystoke for inserting the source element just before the end tag of the target element.
